(19) United States
(12) Patent Application Publication
(10) Pub. No.: US 2018/0076478 A1
(43) Pub. Date: Mar. 15, 2018

(54) SOLID ELECTROLYTE COMPOSITION, ELECTRODE SHEET FOR ALL-SOLID STATE SECONDARY BATTERY, ALL-SOLID STATE SECONDARY BATTERY, AND METHODS FOR MANUFACTURING ELECTRODE SHEET FOR ALL-SOLID STATE SECONDARY BATTERY AND ALL-SOLID STATE SECONDARY BATTERY

(71) Applicant: FUJIFILM Corporation, Tokyo (JP)

(72) Inventors: Tomonori MIMURA, Ashigarakami-gun (JP); Hiroaki MOCHIZUKI, Ashigarakami-gun (JP); Masaomi MAKINO, Ashigarakami-gun (JP); Katsuhiko MEGURO, Ashigarakami-gun (JP)

(73) Assignee: FUJIFILM Corporation, Tokyo (JP)

(21) Appl. No.: 15/819,686

(22) Filed: Nov. 21, 2017

Related U.S. Application Data
(63) Continuation of application No. PCT/JP2016/066765, filed on Jun. 6, 2016.

(30) Foreign Application Priority Data
Jun. 9, 2015 (JP) 2015-116932

(51) Int. Cl. H01M 10/056; H01M 10/0525

(52) U.S. Cl. CPC H01M 10/056; H01M 10/0525; H01M 2300/0071; H01M 2300/0082; H01M 2300/0091

(57) ABSTRACT

Provided are a solid electrolyte composition containing an inorganic solid electrolyte having conductivity of ions of metals belonging to Group I or II of the periodic table, a siloxane compound having a siloxane bond in a branched shape, and a salt of an ion of a metal belonging to Group I or II of the periodic table, respectively, an electrode sheet for an all-solid state secondary battery, an all-solid state secondary battery, and methods for manufacturing an electrode sheet for an all-solid state secondary battery and an all-solid state secondary battery.

### CROSS-REFERENCE TO RELATED APPLICATIONS

This application is a Continuation of PCT International Application No. PCT/JP2016/066765 filed on Jun. 6, 2016, which claims priority under 35 U.S.C. § 119 (a) to Japanese Patent Application No. 2015-116932 filed in Japan on Jun. 9, 2015. Each of the above applications is hereby expressly incorporated by reference, in its entirety, into the present application.

### BACKGROUND OF THE INVENTION

### 1. Field of the Invention

The present invention relates to a solid electrolyte composition, an electrode sheet for an all-solid state secondary battery, an all-solid state secondary battery, and methods for manufacturing an electrode sheet for an all-solid state secondary battery and an all-solid state secondary battery.

### 2. Description of the Related Art

For lithium ion batteries, electrolytic solutions have been used. Attempts are underway to produce all-solid state secondary batteries in which all constituent materials are solid by replacing the electrolytic solutions with solid electrolytes. Reliability in terms of all performance of batteries is an advantage of techniques of using inorganic solid electrolytes. For example, to electrolytic solutions being used for lithium ion secondary batteries, flammable materials such as carbonate-based solvents are applied as media. In secondary batteries for which the above-described electrolytic solutions are used, a variety of safety measures are employed. However, there may be a concern that disadvantages may be caused during overcharging and the like, and there is a demand for additional efforts. All-solid state secondary batteries in which non-flammable electrolytes can be used are considered as a fundamental solution therefor.

Another advantage of all-solid state secondary batteries is the suitability for increasing energy density by means of the stacking of electrodes. Specifically, it is possible to produce batteries having a structure in which electrodes and electrolytes are directly arranged in series. At this time, metal packages sealing battery cells and copper wires or bus-bars connecting battery cells may not be provided, and thus the energy density of batteries can be significantly increased. In addition, favorable compatibility with positive electrode materials capable of increasing potentials and the like can also be considered as advantages.

Due to the respective advantages described above, all-solid state secondary batteries are being developed as next-generation lithium ion batteries (New Energy and Industrial Technology Development Organization (NEDO), Fuel Cell and Hydrogen Technologies Development Department, Electricity Storage Technology Development Section, “NEDO 2013 Roadmap for the Development of Next Generation Automotive Battery Technology” (August, 2013)). For example, JP5375418B proposes the addition of a lithium complex sulfide, a supporting electrolyte salt, a porous particle, and an ion liquid to an electrolyte composition for a secondary battery. In addition, for electrodes for solid state secondary batteries, JP2013-45683A proposes a technique of binding a mixture of powder-form active materials, a solid electrolyte, and an auxiliary conductive agent using a binder of a modified silicone resin having cone structure that is partially substituted with a polar group.

### SUMMARY OF THE INVENTION

However, in JP5375418B, there is a concern that the transport number of lithium ions in an ion liquid being used is small and the efficiency of ion conduction is also low. In addition, JP2013-45683A emphasizes the bonding property of a binder of a modified silicone resin being used. However, the binder itself does not exhibit ion conductivity, and there is room for additional improvement of the efficiency of lithium ion conduction.

That is, in a case in which an inorganic solid electrolyte is used, unlike liquid electrolytes, interfaces are generated among particles, and thus there are portions that are inefficient in terms of conduction in interfaces.

Therefore, an object of the present invention is to provide a solid electrolyte composition having a high transport number of ions of metals belonging to Group I or II of the periodic table and a high ion conductivity, an electrode sheet for an all-solid state secondary battery and an all-solid state secondary battery for which the solid electrolyte composition is used, and methods for manufacturing an electrode sheet for an all-solid state secondary battery and an all-solid state secondary battery.

As a result of intensive studies, the present inventors and the like found that, in a case in which pores that are generated in a particle assembly state of an inorganic solid electrolyte having conductivity of ions of metals belonging to Group I or II of the periodic table is filled with a specific siloxane compound including ions of metals belonging to Group I or II of the periodic table, which are the same as ions for which the inorganic solid electrolyte exhibits ion conductivity, the transport number and ion conductivity of ions of metals belonging to Group I or II of the periodic table improve.

The present invention is based on the above-described finding.

That is, the object is achieved by the following means.

(1) A solid electrolyte composition comprising: an inorganic solid electrolyte having conductivity of ions of metals belonging to Group I or II of the periodic table; a siloxane compound having a siloxane bond in a branched shape; and a salt of an ion of a metal belonging to Group I or II of the periodic table.

(2) The solid electrolyte composition according to (1), which the siloxane compound is a siloxane compound including a partial structure represented by General Formula (S).

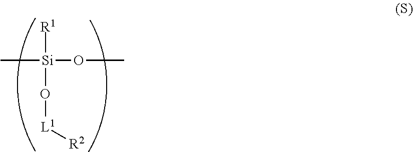

In General Formula (S), R¹ represents a hydrogen atom, a halogen atom, a hydrocarbon group, or —O-L¹-R², and L¹ represents a single bond, an alkylene group, an alkenylene group, an arylene group, —C(═O)—, —N(Ra)-, or a divalent group formed of a combination thereof. Ra represents a hydrogen atom, an alkyl group, or an aryl group. R² represents a hydrogen atom, a hydroxy group, an amino group, a mercapto group, an epoxy group, a cyano group, a carboxy group, a sulfo group, a phosphoric acid group, an alkyl group, an alkenyl group, an alkynyl group, an aryl group, a group including one or more oxyalkylene groups, a group including one or more ester bonds, a group including one or more amide bonds, or a group including one or more siloxane bonds.

(3) The solid electrolyte composition according to (1) or (2), in which the siloxane compound is a siloxane oligomer having a mass average molecular weight of 500 or more and 10,000 or less.

(4) The solid electrolyte composition according to (2), in which —O-L¹-R² that is bonded to a silicon atom is a group represented by General Formula (1s)

—O-L²¹-CO₂R²¹ (1S)

In General Formula (1s), L²¹ represents an alkylene group or an arylene group, and R²¹ represents a hydrogen atom, an alkyl group, an alkenyl group, or an aryl group.

(5) The solid electrolyte composition according to (4), in which a mole fraction of the group represented by General Formula (1s) is 5 mol % or more.

(6) The solid electrolyte composition according to any one of (1) to (5), in which a content of the siloxane compound is 0.1 to 20 parts by mass with respect to 100 parts by mass of the inorganic solid electrolyte in solid components in the solid electrolyte composition.

(7) The solid electrolyte composition according to any one of (1) to (6), in which the inorganic solid electrolyte is selected from compounds represented by any one of the following formulae.
LiₓₐLa_{ya}TiO₃
   0.3≦xa≦0.7 and 0.3≦ya≦0.7
Li_{xb}La_{yb}Zr_{zb}M^{bb}_{mb}O_{nb}
   5≦xb≦10, 1≦yb≦4, 1≦zb≦4, 0≦mb≦2, and 5≦nb≦20
   M^{bb} at least one element selected from the group consisting of Al, Mg, Ca, Sr, V, Nb, Ta, Ti, Ge, In, and Sn
Li_{3.5}Zn_{0.25}GeO₄
LiTi₂P₃O₁₂
Li_{(1+xh+yh)}(Al, Ga)ₓₕ(Ti, Ge)₍₂₋ₓₕ₎Si_{yh}P_{(3-yh)}O₁₂
   0≦xh≦1 and 0≦yh≦1
Li₃PO₄
LiPON
LiPOD¹
   D¹ represents at east one element selected from the group consisting of Ti, V, Cr, Mn, Fe, Co, Ni, Cu, Zr, Nb, Mo, Ru, Ag, Ta, W, Pt, and Au
LiA¹ON
   A¹ represents at least one element selected from the group consisting of Si, B, Ge, Al, C, and Ga
Li_{xc}B_{yc}M^{cc}_{zc}O_{nc}
   0<xc≦5, 0<yc≦1, 0≦zc≦1, and 0<nc≦6
   M^{cc} is at least one element selected from le group consisting of C, S, Al, Si, Ga, Ge, In and Sn
Li₍₃₋₂ₓₑ₎M^{ee}ₓₑD^{ee}O
   M^{ee} is a divalent metallic atom, and D^{ee} is a halogen atom or a combination or more kinds of halogen atoms
Li_{xf}Si_{yf}O_{zf}
   1≦xf≦5, 0<yf≦3, and 1≦zf≦10
Li_{xg}Si_{yg}O_{zg}
   1≦xg≦3, 0<yg≦2, and 1≦zg≦10

(8) The solid electrolyte composition according to any one of (1) to (6), in which the inorganic solid electrolyte is a compound represented by General Formula (SE).

L^{aa}ₐ₁M^{aa}_{b1}P_{c1}S_{d1}A^{aa}ₑ₁ (SE)

In General Formula (SE), L^{aa} represents an element selected from Li, Na, and K, M^{aa} represents an element selected from B, Zn, Sn, Si, Cu, Ga, Sb, Al, and Ge, and A^{aa} represents I, Br, Cl, or F. a1 to e1 represent compositional ratios of the respective elements, and a1:b1:c1:d1:e1 satisfies 1 to 12:0 to 1:1:2 to 12:0 to 5.

(9) The solid electrolyte composition according to any one of (1) to (8), in which the salt of metallic ion belonging to Group I or II of the periodic table is a lithium salt.

(10) The solid electrolyte composition according to any one of (1) to (9), further comprising: a binder.

(11) The solid electrolyte composition according to (10), in which the binder is a hydrocarbon resin, a fluororesin, an acrylic resin, or a polyurethane resin.

(12) A method for manufacturing an electrode sheet for an all-solid state secondary battery, the method comprising: applying the solid electrolyte composition according to any one of (1) to (11) onto a metal foil; and forming a film.

(13) An electrode sheet for an all-solid state secondary battery having a positive electrode active material layer; a solid electrolyte layer; and a negative electrode active material layer in this order, in which any one layer of the positive electrode active material layer, the solid electrolyte layer, and the negative electrode active material layer contains an inorganic solid electrolyte having conductivity of ions of metals belonging to Group I or II of the periodic table, a siloxane compound having a siloxane bond in a branched shape, and a salt of an ion of a metal belonging to Group I or II of the periodic table, respectively.

(14) An all-solid state secondary battery constituted using the electrode sheet for an all-solid state secondary battery according to (13).

(15) A method for manufacturing an all-solid state secondary battery, the method comprising: manufacturing an all-solid state secondary battery having a positive electrode active material layer, a solid electrolyte layer, and a negative electrode active material layer in this order through the manufacturing method according to (12).

In the present specification, numerical ranges expressed using “to” include numerical values before and after the “to” as the lower limit value and the upper limit value.

In the present specification, when a plurality of substituents represented by specific symbols is present or a plurality of substituents or the like is simultaneously or selectively determined (similarly, when the number of substituents is determined), the respective substituents and the like may be identical to or different from each other. In addition, when a plurality of substituents or the like are adjacent to one another, the substituents or the like may be bonded or condensed to each other and thus form a ring. Meanwhile, in a case in which substituents are simply mentioned, regarding specific substituents thereof, substituent T is referred to, and, unless particularly otherwise described, regarding the expression of “optionally substituted”, the substituent of substituent T is referred to.

In the present specification, the expression “acryl” that is simply mentioned is used to refer to both acryl and methacryl. Meanwhile, the expression “(meth)” in (meth)acryl and the like is used to refer to both acryl and methacryl and may be any one of acryl and methacryl or a mixture thereof.

The present invention decreases the intrinsic interface resistance of the inorganic solid electrolyte and thus enables the provision of a solid electrolyte composition having a high transport number of ions of metals belonging to Group I or II of the periodic table and a high ion conductivity, an electrode sheet for an all-solid state secondary battery and an all-solid state secondary battery for which the solid electrolyte composition is used. In addition, the present invention enables the provision of methods for manufacturing an electrode sheet for an all-solid state secondary battery and an all-solid state secondary battery which exhibit excellent performance as described above.

The above-described and other characteristics and advantages of the present invention will be further clarified by the following description with appropriate reference to the accompanying drawings.

### BRIEF DESCRIPTION OF THE DRAWINGS

FIG. 1 is a vertical cross-sectional view schematically illustrating an all-solid state lithium ion secondary battery according to a preferred embodiment of the present invention.

FIG. 2 is a vertical cross-sectional view schematically illustrating a testing device used in examples.

### DESCRIPTION OF THE PREFERRED EMBODIMENTS

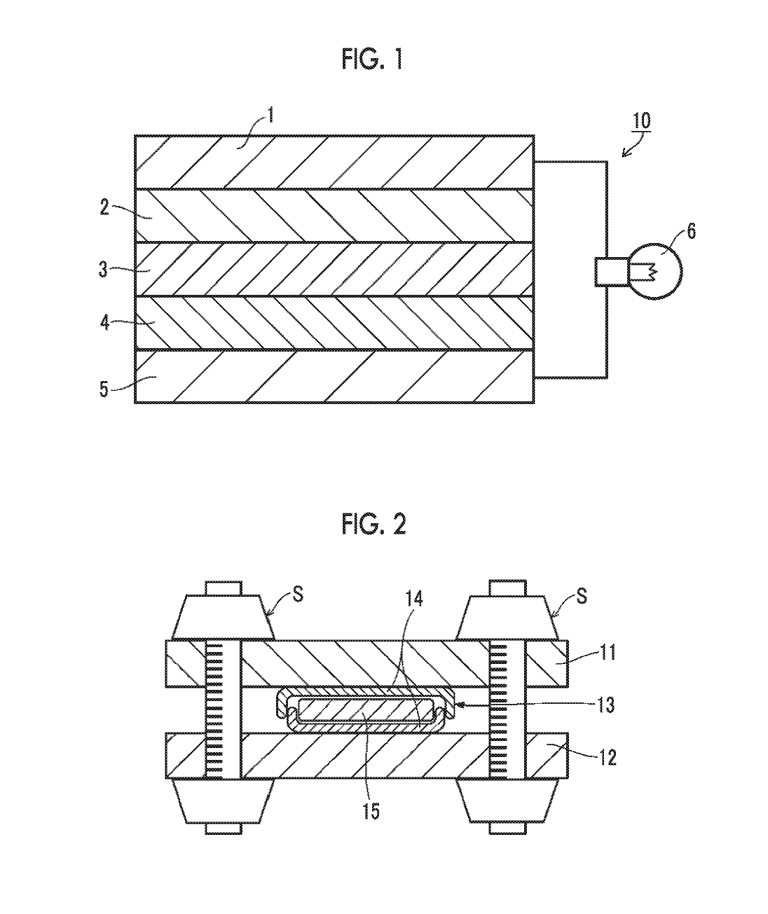

FIG. 1 is a cross-sectional view schematically illustrating an all-solid state secondary battery (lithium ion secondary battery) according to a preferred embodiment of the present invention. In the case of being seen from the negative electrode side, an all-solid state secondary battery 10 of the present embodiment has a negative electrode collector 1, a negative electrode active material layer 2, a solid electrolyte layer 3, a positive electrode active material layer 4, and a positive electrode collector 5 in this order. The respective layers are in contact with one another and have a laminated structure. In a case in which the above-described structure is employed, during charging, electrons (e⁻) are supplied to the negative electrode side, and lithium ions (Li⁺) are accumulated on the negative electrode side. On the other hand, during discharging, the lithium ions (Li⁺) accumulated on the negative electrode side return to the positive electrode, and electrons are supplied to an operation portion 6. In an example illustrated in the drawing, an electric bulb is employed as the operation portion 6 and is lit by discharging. The solid electrolyte composition of the present invention can be preferably used as a material used to form the negative electrode active material layer, the positive electrode active material layer, and the solid electrolyte layer.

In the present specification, there are cases in which the positive electrode active material layer and the negative electrode active material layer are collectively referred to as electrode layers. In addition, as electrode active materials that are used in the present invention, there are a positive electrode active material that is included in the positive electrode active material layer and a negative electrode active material that is included in the negative electrode active material layer, and there are cases in which either or both layers are simply referred to as active materials.

The thicknesses of the positive electrode active material layer 4, the solid electrolyte layer 3, and the negative electrode active material layer 2 are not particularly limited. Meanwhile, in a case in which the dimensions of ordinary batteries are taken into account, the thicknesses are preferably 10 to 1,000 μm and more preferably 20 μm or more and less than 500 μm. In the all-solid state secondary battery of the present invention, the thickness of at least one layer of the positive electrode active material layer 4, the solid electrolyte layer 3, and the negative electrode active material layer 2 is still more preferably 50 μm or more and less than 500 μm.

<<Solid Electrolyte Composition>>

Hereinafter, components in the solid electrolyte composition of the present invention will be described. The solid electrolyte composition of the present invention is preferably applied as a material used to form the positive electrode active material layer, the solid electrolyte layer, and the negative electrode active material layer.

<Siloxane Compound Having a Siloxane Bond in Branched Shape>

The solid electrolyte composition of the present invention contains a siloxane compound having a siloxane bond in a branched shape.

The siloxane compound having a siloxane bond in a branched shape refers to a compound in which all of at least three groups bonded to the same silicon atom have at least one siloxane bond (Si—O). Meanwhile, for example, tetraethoxysilane is not the siloxane compound of the present invention since groups bonded to a silicon atom are all ethoxy groups and the ethoxy groups do not have any siloxane bonds.

The siloxane compound that is used in the present invention may be a monomer, a dimer or higher oligomer, or a polymer; however, in the present invention, is preferably an oligomer (that is, a siloxane oligomer). In addition, the “same atom” is preferably a silicon atom.

In the present invention, molecules having a mass average molecular weight of 10,000 or less in terms of styrene are also considered as oligomers.

The siloxane compound that is used in the present invention is preferably a siloxane compound including a partial structure represented by General Formula (S) and is more preferably a siloxane oligomer including the partial structure represented by General Formula (S).

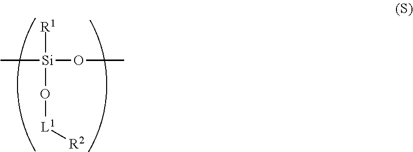

In General Formula (S), R¹ represents a hydrogen atom, a halogen atom, a hydrocarbon group, or —O-L¹-R², and L¹ represents a single bond, an alkylene group, an alkenylene group, an arylene group, —C(═O)—, —N(Ra)-, or a divalent group formed of a combination thereof. Here, Ra represents a hydrogen atom, an alkyl group, or an aryl group. R² represents a hydrogen atom, a hydroxy group, an amino group, a mercapto group, an epoxy group, a cyano group, a carboxy group, a sulfo group, a phosphoric acid group, an alkyl group, an alkenyl group, an alkynyl group, an aryl group, a group including one or more oxyalkylene groups, a group including one or more ester bonds, a group including one or more amide bonds, or a group including one or more siloxane bonds.

Here, in the siloxane compound or siloxane oligomer having the partial structure represented by General Formula (S), it is more preferable that R¹ is bonded to, in General Formula (S), the bonding terminal on the left side (Si side) in the drawing of the bond connected to the —Si(R¹)(OL¹R²)—O— bond having the silicon atom (hereinafter, referred to as Si) to which R¹ is bonded and R¹ or -L¹-R² is bonded to the, bonding terminal on the right side (O side) in the drawing.

The halogen atom as R¹ is preferably a fluorine atom, a chlorine atom, or a bromine atom.

The hydrocarbon group as R¹ is a group made up of a carbon atom and a hydrogen atom and may have a linear shape, a branched shape, or a cyclic shape. In addition, the hydrocarbon group may be substituted with a substituent.

The hydrocarbon group is preferably an alkyl group (preferably having 1 to 20 carbon atoms and more preferably 1 to 10 carbon atoms), an alkenyl group (preferably having 2 to 20 carbon atoms and more preferably 2 to 10 carbon atoms), an alkynyl group (preferably having 2 to 20 carbon atoms and more preferably 2 to 10 carbon atoms), a cycloalkyl group (preferably having 3 to 20 carbon atoms and more preferably 5 to 10 carbon atoms), a cycloalkenyl group (preferably having 5 to 20 carbon atoms and more preferably 5 to 10 carbon atoms), or an aryl group (preferably having 6 to 20 carbon atoms and more preferably 6 to 10 carbon atoms).

Among these, the hydrocarbon group as R¹ is preferably an alkyl group, an alkenyl group, a cycloalkyl group, or an aryl group.

In addition, the substituent that may substitute the hydrocarbon group is preferably an alkyl group, an aryl group, an alkoxy group, an aryloxy group, an alkylthio group, an arylthio group, a halogen atom, a hydroxy group, a mercapto group, an amino group, a cyano group, or an isocyanate group (—N═C═O). Meanwhile, the alkyl group is preferably a halogenated alkyl group that is substituted with a halogen atom.

L¹ is a single bond, an alkylene group (preferably having 1 to 20 carbon atoms and more preferably 1 to 10 carbon atoms), an alkenylene group (preferably having 2 to 20 carbon atoms and more preferably 2 to 10 carbon atoms), an arylene group (preferably having 6 to 20 carbon atoms and more preferably 6 to 10 carbon atoms), —C(═O)—, —N(Ra)-, or a divalent group formed of a combination thereof, and examples of the divalent group formed of a combination thereof include —C(═O)—N(Ra)-, —N(Ra)-C(═O)—, -alkylene-arylene-, -alkylene-C(═O)—, -alkylene-N(Ra)-, -alkylene-C(═O)—N(Ra)-, and -alkylene-N(Ra)-C(═O)—.

The groups other than the single bond as L¹ may also have a substituent.

The above-described substituent is preferably an alkyl group, an alkenyl group, an alkynyl group, an aryl group, a halogen atom, or a hydroxy group, and the alkyl group is preferably a halogenated alkyl group that is substituted with a halogen atom.

Meanwhile, the number of carbon atoms in the alkyl group as Ra is preferably 1 to 20 and more preferably 1 to 10, and the number of carbon atoms in the aryl group is preferably 6 to 20 and more preferably 6 to 10.

The number of carbon atoms in the alkyl group, the alkenyl group, the alkylnyl group, or the aryl group as R² is preferably the number of carbon atoms in the alkyl group, the alkenyl group, the alkynyl group, and the aryl group that are exemplified as the hydrocarbon group as R¹.

The group including one or more oxyalkylene groups as R² is preferably —(CH₂CH₂O)ₗ₁—Rb, —[CH(CH₃)CH₂O]ₗ₁—Rb, or —[CH₂CH(CH₃)O]ₗ₁—Rb. Here, l1 represents a numerical value of 1 to 10, and Rb represents a hydrogen atom, an alkyl group, or an aryl group.

The group including one or more ester bonds as R² is preferably —C(═O)—ORc. Here, Rc represents a hydrogen atom, an alkyl group, an alkenyl group, or an aryl group.

The group including one or more amide bonds as R² is preferably —C(═O)—N(Rd)(Re). Here, Rd and Re each independently represent a hydrogen atom, an alkyl group, or an aryl group.

The alkyl group and aryl group as Rb to Re are the same as the alkyl group and the aryl group as Ra, and preferred ranges thereof are also identical.

The group including one or more siloxane bonds as R² is preferably a group including 1 to 100 siloxane bonds and e preferably a group represented by General Formula (1r).

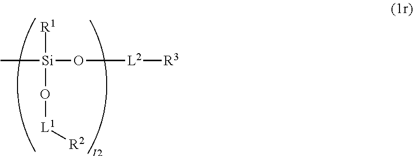

In General Formula (1r), R¹, R², and L¹ are the same as R¹, R², and L¹ in General Formula (S), and preferred ranges thereof are also identical. L² is the same as L¹, and a preferred range thereof is also identical. R³ is the same as R², and a preferred range thereof is also identical, l2 represents a numerical value of 1 to 100.

l2 is preferably a numerical value of 1 to 50.

In General Formula (S), —O-L¹-R² bonded to the silicon atom is preferably a group represented by General Formula (1s).

—O-L²¹CO₂R²¹ (1s)

In General Formula (1s), L²¹ represents an alkylene group or an arylene group, and R²¹ represents a hydrogen atom, an alkyl group, an alkenyl group, or an aryl group.

Between an alkylene group (preferably having 1 to 20 carbon atoms and more preferably having 1 to 10 carbon atoms) and the arylene group (preferably having 6 to 20 carbon atoms and more preferably 6 to 10 carbon atoms), L²¹ is preferably an alkylene group. In addition, the alkylene group and the arylene group may have a substituent. Among these substituents, an alkyl group, an alkenyl group, an alkynyl group, an aryl group, an alkoxy group, an aryloxy group, an alkylthio group, an arylthio group, a hydroxy group, or a halogen atom are preferred. Meanwhile, the alkyl group is preferably a halogenated alkyl group that is substituted with a halogen atom.

Among a hydrogen atom, an alkyl group (preferably having 1 to 20 carbon atoms and more preferably having 1 to 10 carbon atoms), an alkenyl group (preferably having 2 to 20 carbon atoms and more preferably having 2 to 10 carbon atoms), and aryl group (preferably having 6 to 20 carbon atoms and more preferably 6 to 10 carbon atoms), R²¹ is preferably a hydrogen atom or an alkyl group and more preferably a hydrogen atom.

In a case in which the siloxane compound that is used in the present invention is a siloxane oligomer, the siloxane oligomer is preferably an oligomer that condensation-polymerizes a compound represented by General Formula (MS).

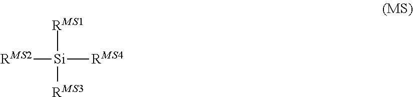

In General Formula (MS), R^{MS1} represents a hydrogen atom, a hydrocarbon group, or —O—R^{MS}. R^{MS2} to R^{MS4} each independently represent —O—R^{MS} or a halogen atom. Here, R^{MS} represents a hydrogen atom or a hydrocarbon group.

In the compound represented by General Formula (MS), three groups of R^{MS2} to R^{MS4} serve as active groups for condensation reactions, these groups enable condensation in three or four directions, and not linear oligomers but oligomers having a branched structure in which siloxane bond is present in a branched shape can be synthesized.

The hydrocarbon groups as R^{MS1} to R^{MS} are the same as the hydrocarbon group in General Formula (S) and preferred ranges thereof are also identical. Here, R^{MS} is preferably an alkyl group.

The halogen atoms as R^{MS2} to R^{MS4} are the same as the halogen atom in General Formula (S), and preferred ranges thereof are also identical.

Hereinafter, specific examples of the compound represented by General Formula (MS) will be illustrated, but the present invention is not limited thereto.

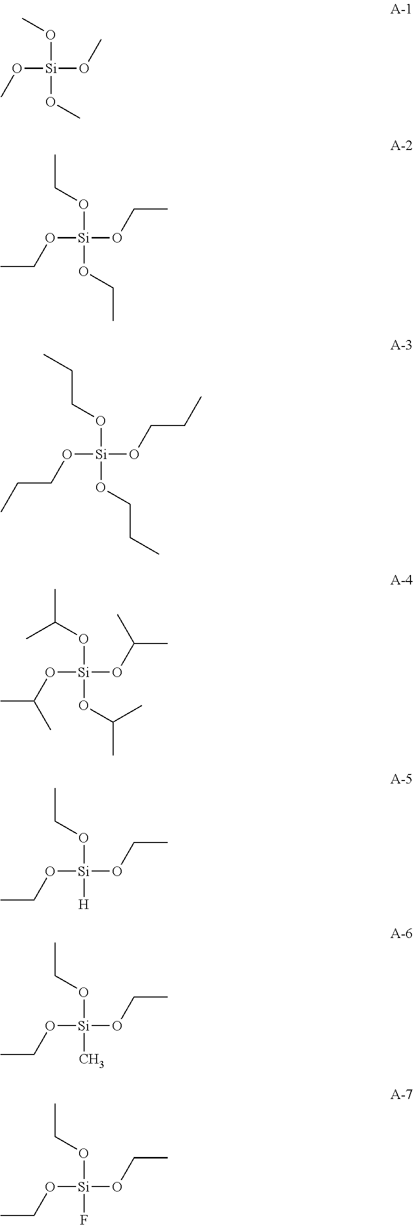

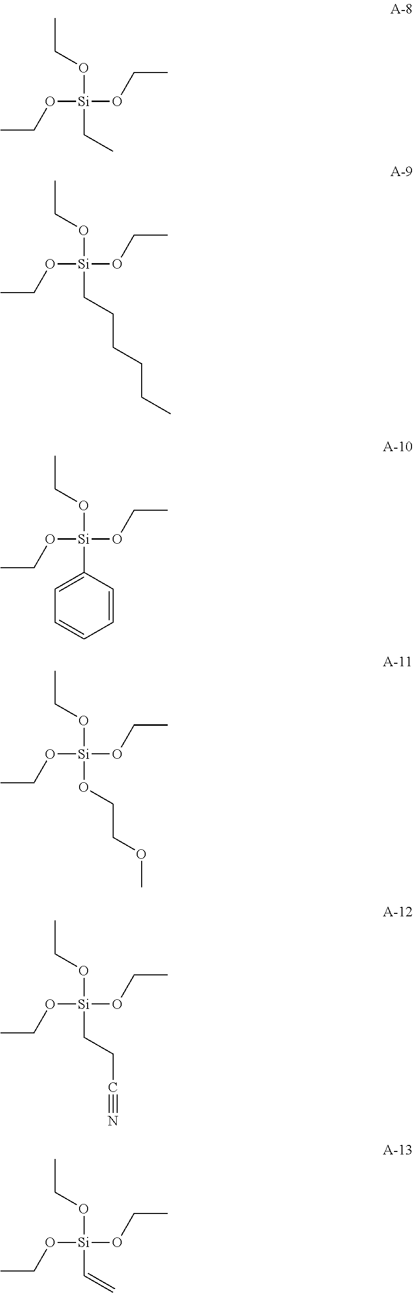

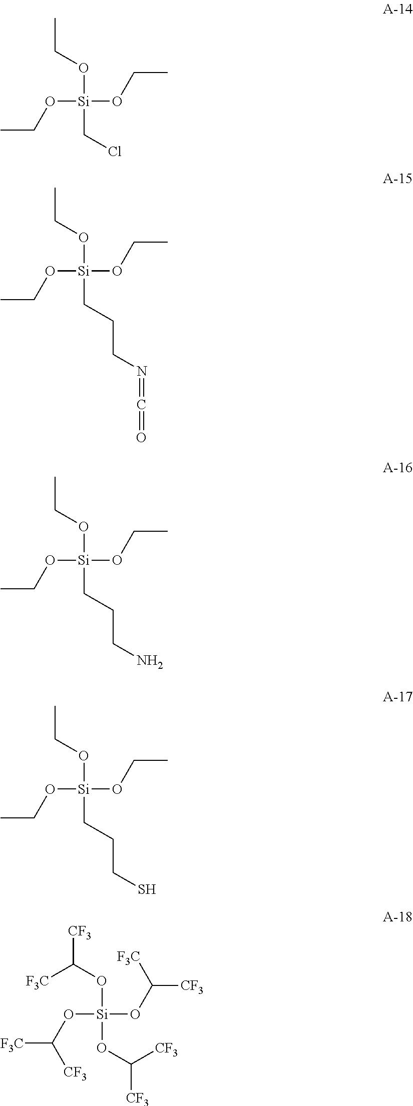

In a case in which the siloxane compound that is used in the present invention is the siloxane oligomer having the partial structure represented by General Formula (S), the siloxane oligomer can be synthesized by reacting the compound represented by General Formula (MS) and the compound represented by General Formula (HA).

HO-L²¹-CO₂R²¹ (HA)

In General Formula (HA), L²¹ and R²¹ are the same as L²¹ and R²¹ in General Formula (1s), and preferred ranges thereof are also identical.

Hereinafter, specific examples of the compound represented by General Formula (HA) will be illustrated, but the present invention is not limited thereto.

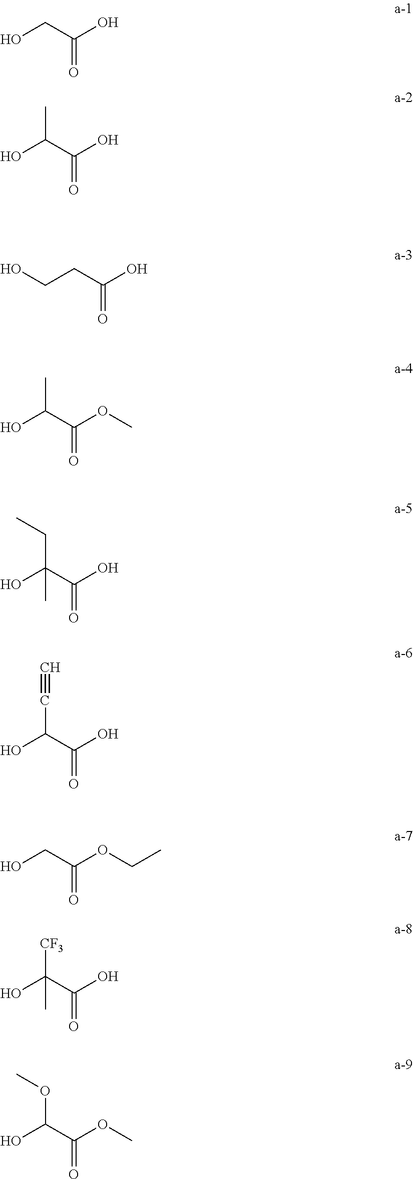

Particularly, in a case in which R²¹ in General Formula (HA) is a hydrogen atom, the compound also acts as an acid catalyst for the condensation polymerization of the compound represented by General Formula (MS).

Here, in the compound represented by General Formula (HA), —CO₂R²¹ in General Formula (HA) (in this case, R²¹ is a hydrogen atom) is esterified due to an ester exchange with any —OR^{MS} in the compound represented by General Formula (MS), and the compound represented by General Formula (HA) turns into an ester body in which R²¹ is changed to any R^{MS} in the compound represented by General Formula (MS). Subsequently, the ester body reacts with any one —OR^{MS} remaining the oligomer obtained from the compound represented by General Formula (MS), and —O-L²¹-CO₂R²¹ is introduced into the oligomer. At this time, in a case in which another hydroxy compound is caused to coexist, it is also possible to cause the hydroxy compound to react with any one —OR^{MS} remaining the oligomer and combine the hydroxy compound into the oligomer.

The reaction between the compound represented by General Formula (MS) and the compound represented by General Formula (HA) will be schematically illustrated using the following reaction scheme. Here, the structural unit of the branched portion is not illustrated in order to specifically describe the reaction.

Here, the compound represented by General Formula (MS) is indicated by General Formula (MS-1) in which R^{MS1} is a hydrogen atom or a hydrocarbon group (hereinafter, referred to as R^{MS00}), R^{MS2} to R^{MS4} are —O—R^{MS}, and R^{MS} is a hydrocarbon group (hereinafter, referred to as R^{MS0}), and the compound represented by General Formula (HA) is indicated by General Formula (HA-1) in which R²¹ is a hydrogen atom. HO—R^{r} is the coexisting hydroxy compound, and R^{r} is a hydrocarbon group.

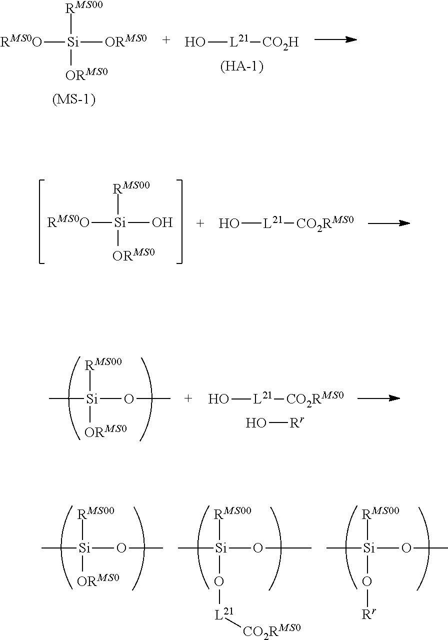

The use of a compound represented by General Formula (MX) together with the compound represented by General Formula (MS) enables the production of a copolymerized oligomer of —O-L¹-R² (—O-L²¹-CO₂R^{MS0} in the above-illustrated reaction scheme) and the siloxane oligomer to be combined.

In the present invention, it is preferable to use the compound represented by General Formula (MS) alone rather than the above-described copolymerized oligomer.

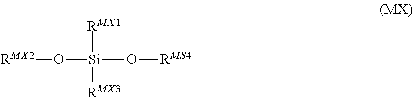

In General Formula (MX), R^{MX1} and R^{MX3} each independently represent a hydrogen atom or a hydrocarbon group. R^{MX2} and R^{MX4} each independently represent a hydrocarbon group.

The hydrocarbon groups as R^{MX1} to R^{MX4} are the same as the hydrocarbon groups in General Formula (MS), and preferred ranges thereof are also identical.

Examples of the compound represented by General Formula (MX) include dimethyldiethoxysilane, methylphenyldiethoxysilane, methylcyclohexyldiethoxysilane, diphenyldiethoxysilane, dicyclohexyldiethoxysilane, cyclohexylphenyldiethoxysilane, and the like.

In the present invention, the content of the compound represented by General Formula (MX) is preferably 0 to 1,000 mol, more preferably 0 to 200 mol, and still more preferably 0 to 50 mol with respect to 100 mol of the compound represented by General Formula (MS).

In the present invention, two or more kinds of the compound represented by General Formula (MS) may be used, and two or more kinds of the compound represented by General Formula (HA) may be used.

In addition, in the case of being used, similarly, two or more kinds of the compound represented by General Formula (MX) may be used.

The molecular weight or mass average molecular weight of the siloxane compound that is used in the present invention is preferably 500 or more and 10,000 or less, more preferably 500 or more and 5,000 or less, and still more preferably 1,000 or more and 5,000 or less.

Meanwhile, the mass average molecular weight refers to the mass average molecular weight in terms of standard polystyrene measured by means of gel permeation chromatography (GPC), and specifically, is measured using the method described in the section of examples.

The siloxane compound that is used in the present invention preferably contains group represented by General Formula (1s) in a mole fraction of 5 mol % or more in the siloxane compound.

The mole fraction of the group represented by General Formula (1s) is more preferably 5 mol % or more and 60 mol % or less, still more preferably 10 mol % or more and 50 mol % or less, and particularly preferably 20 mol % or more and 40 mol % or less.

In a case in which the mole fraction of the group represented by General Formula (1s) is set in the above-described preferred range, the viscosity decreases, and it is possible to realize high ion conductivity.

Meanwhile, the mole fraction of the group represented by General Formula (1s) can be adjusted by adjusting the mixing amount of the compound represented by General Formula (HA) or adjusting the reaction temperature in the synthesis of the siloxane oligomer.

Here, in a case in which a plurality of the groups represented by General Formula (1s) is present in the oligomer molecule, the groups may be identical to or different from one another. Meanwhile, the mole fraction of the group represented by General Formula (1s) is the total of the mole fractions of the plurality of groups.

The mole fraction of the group represented by General Formula (1s) can be obtained from ¹H-NMR.

The siloxane compound that is used in the present invention can be synthesized using an ordinary method for synthesizing siloxane oligomers. For example, the siloxane compound can be synthesized using the method described in JP2012-89468A.

The content of the siloxane compound that is used in the present invention in the solid electrolyte composition is preferably 0.1 parts by mass to 60 parts by mass, more preferably 0.1 parts by mass to 30 parts by mass, still more preferably 0.1 parts by mass to 20 parts by mass, particularly preferably 0.5 parts by mass to 10 parts by mass, and most preferably parts by mass to 10 parts by mass of all of the solid components in the solid electrolyte composition.

Meanwhile, the solid components in the present specification refer to components that do not disappear through volatilization or evaporation when dried in a vacuum at 170° C. for six hours. Typically, the solid components refer to components other than a dispersion medium described below.

In the present specification, substituents which are not clearly expressed as substituted or unsubstituted (which is also true for linking groups) may have an arbitrary substituent in the groups. This is also true for compounds which are not clearly expressed as substituted or unsubstituted. Examples of preferred substituents include the following substituent T.

Examples of the substituent T include the following substituents.

Alkyl groups (preferably alkyl groups having 1 to 20 carbon atoms, for example, methyl, ethyl, isopropyl, t-butyl, pentyl, heptyl, 1-ethylpentyl, benzyl, 2-ethoxyethyl, 1-carboxymethyl, and the like), alkenyl groups (preferably alkenyl groups having 2 to 20 carbon atoms, for example, vinyl, allyl, oleyl, and the like), alkynyl groups (preferably alkynyl groups having 2 to 20 carbon atoms, for example, ethynyl, butadiynyl, phenylelynyl, and the like), cycloalkyl groups (preferably cycloalkyl groups having 3 to 20 carbon atoms, for example, cyclopropyl, cyclopentyl, cyclohexyl, 4-methylcyclohexyl, and the like), aryl groups (preferably aryl groups having 6 to 26 carbon atoms, for example, phenyl, 1-naphthyl, 4-methoxyphenyl, 2-chlorophenyl, 3-methylphenyl, and the like), heterocyclic groups (preferably heterocyclic groups having 2 to 20 carbon atoms, preferably heterocyclic groups of a five- or six-membered ring having at least one oxygen atom, sulfur atom, or nitrogen atom, for example, tetrahydropyran, tetrahydrofuran, 2-pyridyl, 4-pyridyl, 2-imidazolyl, 2-benzimidazolyl, 2-thiazolyl, 2-oxazolyl, and the like).

alkoxy groups (preferably alkoxy groups having 1 to 20 carbon atoms, for example, methoxy, ethoxy, isopropyloxy, benzyloxy, and the like), aryloxy groups (preferably aryloxy groups having 6 to 26 carbon atoms, for example, phenoxy, 1-naphthyloxy, 3-methylphenoxy, 4-methoxyphenoxy, and the like), alkoxycarbonyl groups (preferably alkoxycarbonyl groups having 2 to 20 carbon atoms, for example, ethoxycarbonyl, 2-ethylhexyloxycarbonyl, and the like), aryloxycarbonyl groups (preferably aryloxycarbonyl groups having 6 to 26 atoms, for example, phenoxycarbonyl, 1-naphthyloxycarbonyl, 3-methylphenoxycarbonyl, 4-methoxyphenoxycarbonyl, and the like), amino groups (preferably amino groups having 0 to 20 carbon atoms, including an alkylamino group, anal an acylamino group, for example, amino, N,N-dimethylamino, N,N-diethylamino, N-ethylamino, anilino, and the like), sulfamoyl groups (preferably sulfamoyl groups having 0 to 20 carbon atoms, for example, N,N-dimethylsulfamoyl, N-phenylsulfamoyl, and the like), acyl groups (preferably acyl groups having 1 to 20 carbon atoms, for example, acetyl, propionyl, butyryl, and the like), aryloyl groups (preferably aryloyl groups having 7 to 23 carbon atoms, for example, benzoyl and the like), acyloxy groups (preferably acyloxy groups having 1 to 20 carbon atoms, for example, acetyoxy and the like), aryloyloxy groups (preferably aryloyloxy groups having 7 to 23 carbon atoms, for example, benzoyloxy and the like).

carbamoyl groups (preferably carbamoyl groups having 1 to 20 carbon atoms, for example, N,N-dimethylcarbamoyl, N-phenylcarbamoyl, and the like), acylamino groups (preferably acylamino groups having 1 to 20 carbon atoms, for example, acetylamino, benzoylamino, and the like), alkylthio groups (preferably alkylthio groups having 1 to 20 carbon atoms, for example, methylthio, ethylthio, isopropylthio, benzylthio, and the like), arylthio groups (preferably arylthio groups having 6 to 26 carbon atoms, for example, phenylthio, 1-naphthylthio, 3-methylphenylthio, 4-methoxyphenylthio, and the like), alkylsulfonyl groups (preferably alkylsulfonyl groups having 1 to 20 carbon atoms, for example, methylsulfonyl, ethylsulfonyl, and the like), arylsulfonyl groups (preferably arylsulfonyl groups having 6 to 22 carbon atoms, for example, benzenesulfonyl and the like), alkylsilyl groups (preferably alkylsilyl groups having 1 to 20 carbon atoms, for example, monomethylsilyl, dimethylsilyl, trimethylsilyl, triethylsilyl, and the like), arylsilyl groups (preferably arylsilyl groups having 6 to 42 carbon atoms, for example, triphenylsilyl, and the like), phosphoryl groups (preferably phosphoric acid groups having 0 to 20 carbon atoms, for example, —OP(═O)(R^{P})₂), phosphonyl groups (preferably phosphonyl groups having 0 to 20 carbon atoms, for example, —P(═O)(R^{P})₂), phosphinyl groups (preferably phosphinyl groups having 0 to 20 carbon atoms, for example, —P(R^{P})₂), a (meth)acryloyl group, a (meth)acryloyloxy group, a hydroxyl group, a cyano group, halogen atoms (for example, a fluorine atom, a chlorine atom, a bromine atom, an iodine atom, and the like).

In addition, in the respective groups exemplified as the substituent T, the substituent T may be further substituted.

<Salt of Ion of Metal Belonging to Group I or II of Periodic Table>

The solid electrolyte composition of the present invention contains, together with the siloxane compound that is used in the present invention, a salt of an ion of a metal belonging to Group I or II of the periodic table.

In the present invention, the salt of an ion of a metal belonging to Group I or II of the periodic table is different from the inorganic solid electrolyte having conductivity of ions of metals belonging to Group I or II of the periodic table.

That is, the salt of an ion of a metal belonging to Group I or II of the periodic table is a salt made up of an ion of a metal belonging to Group I or II of the periodic table and an inorganic or organic ion, and these ions are disassociated or liberated into cations and anions in the siloxane compound that is used in the present invention.

Examples of the metal belonging to Group I or II of the periodic table include Li, Na, K, Rb, Cs, Mg, and Ca. Among these, Li, Na, and Mg are preferred, and, particularly, Li is preferred.

Meanwhile, the salt of an ion of the metal belonging to Group I or II of the periodic table may be an inorganic salt or organic salt of an ion of the metal belonging to Group I or II of the periodic table, but is preferably an organic salt.

Specific examples thereof include inorganic salts and organic salts exemplified as lithium salts described below.

Among these, the salt of an ion of the metal belonging to Group I or II of the periodic table that is used in the present invention is preferably a salt of an ion of a metal belonging to Group I or II of the periodic table which dissolves in the siloxane compound that is used in the present invention.

In the present invention, the salt of an ion of the metal belonging to Group I or II of the periodic table is preferably a lithium salt.

(Lithium Salt)

The lithium salt is preferably a lithium salt that is ordinarily used in this kind of products and is not particularly limited, and, for example, salts described below are preferred.

(L-1) Inorganic Lithium Salts

Inorganic fluoride salts such as LiPF₆, LiBF₄, LiAsF₆, and LiSbF₆; perhalogen acid salts such as LiClO₄, LiBrO₄, and LiIO₄; inorganic chloride salts such as LiAlCl₄; and the like

(L-2) Fluorine-Containing Organic Lithium Salts

Perfluoroalkanesulfonate salts such as LiCF₃SO₃; perfluoroalkanesulfonylimide salts such as LiN(CF₃SO₂)₂, LiN(CF₃CF₂SO₂)₂, LiN(FSO₂)₂, and LiN(CF₃SO₂)(C₄F₉SO₂); perfluoroalkanesulfonyl methide salts such as LiC(CF₃SO₂)₃; fluoroalkyl fluorophosphates salts such as Li[PF₅(CF₂CF₂CF₃)], Li[PF₄(CF₂CF₂CF₃)₂], Li[PF₃(CF₂CF₂CF₃)₃], Li[PF₅(CF₂CF₂CF₂CF₃)], Li[PF₄(CF₂CF₂CF₂CF₃) 2], and Li[PF₃(CF₂CF₂CF₂CF₃)₃], and the like

(L-3) Oxalate Borate Salts

Lithium bis(oxalato)borate lithium difluorooxalatoborate, and the like

Among these, LiPF₆, LiBF₄, LiAsF₆, LiSbF₆, LiClO₄, Li(Rf¹SO₃), LiN(Rf¹SO₂)₂, LiN(FSO₂)₂, and LiN(Rf¹SO₂)(Rf²SO₂) are preferred, and lithium imide salts such as LiPF₆, LiBF₄, LiN(Rf¹SO₂)₂, LiN(FSO₂)₂, and LiN(Rf¹SO₂)(Rf²SO₂) are more preferred. Here, Rf¹ and Rf² each independently represent a perfluoroalkyl group.

Meanwhile, these salts of an ion of the metal belonging to Group I or II of the periodic table (preferably lithium salts) may be used singly or two or more salts may be arbitrarily combined together.

The blending amount of the salt of an ion of the metal belonging to Group I or II of the periodic table is preferably 10 parts by mass or more and 200 parts by mass or less, more preferably 20 parts by mass or more and 100 parts by mass or less, and still more preferably 30 parts by mass or more and 80 parts by mass or less with respect to 100 parts by mass of the siloxane compound that is used in the present invention.

In a case in which the blending amount is set in the above-described preferred range, the concentration and viscosity of the salt of an ion of the metal belonging to Group I or II of the periodic table (preferably the Li salt) become appropriate, and it is possible to increase ion conductivity.

In the present invention, in the preparation of the solid electrolyte composition, it is preferable to disperse the inorganic solid electrolyte in a mixture obtained by mixing the siloxane compound and the salt of an ion of the metal belonging to Group I or II of the periodic table which are used in the present invention or, preferably, dissolving the salt of an ion of the metal belonging to Group I or II of the periodic table in the siloxane compound and use the product as the solid electrolyte composition.

<Inorganic Solid Electrolyte Having Conductivity of Ions of Metals Belonging to Group I or II of the Periodic table>

The solid electrolyte composition of the present invention contains, together with the siloxane compound and the salt of an ion of the metal belonging to Group I or II of the periodic table which are used in the present invention, an inorganic solid electrolyte having conductivity of ions of metals belonging to Group I or II of the periodic table.

The inorganic solid electrolyte is an inorganic solid electrolyte, and the solid electrolyte refers to a solid-form electrolyte capable of migrating ions therein. The inorganic solid electrolyte is clearly differentiated from organic solid electrolytes (macromolecular electrolytes represented by PEO or the like, organic electrolyte salts which are represented by LiTFSI or the like and are organic salts of ions of metals belonging to Group I or II of the periodic table, and the like) since the inorganic solid electrolyte does not include any organic substances as a principal ion-conductive material. In addition, the inorganic solid electrolyte is a solid in a static state and is thus, generally, not disassociated or liberated into cations and anions. Due to this fact, the inorganic solid electrolyte is also clearly differentiated from inorganic electrolyte salts which are disassociated or liberated into cations and anions in electrolytic solutions or polymers and are inorganic salts of ions of metals belonging to Group I or II of the periodic table (LiPF₆, LiBF₄, LiFSI, LiCl, and the like). The inorganic solid electrolyte is not particularly limited as long as the inorganic solid electrolyte has conductivity of ions of metals belonging to Group I or II of the periodic table and is generally a substance not having electron conductivity.

In the present invention, the inorganic solid electrolyte has ion conductivity of ions of metals belonging to Group I or II of the periodic table. As the inorganic solid electrolyte, it is possible to appropriately select and use solid electrolyte materials that are applied to this kind of products. Typical examples of the inorganic solid electrolyte include (i) sulfide-based inorganic solid electrolytes and (ii) oxide-based inorganic solid electrolytes.

(i) Sulfide-Based Inorganic Solid electrolytes

Sulfide-based inorganic solid electrolytes are preferably inorganic solid electrolytes which contain sulfur atoms (S), have ion conductivity of metals belonging to Group I or II of the periodic table, and have electron-insulating properties. The sulfide-based inorganic solid electrolytes are preferably inorganic solid electrolytes which, as elements, contain at least Li, S, and P and have a lithium ion conductivity, but the sulfide-based inorganic solid electrolytes may also include elements other than Li, S, and P depending on the purposes or cases.

Examples thereof include lithium ion-conductive inorganic solid electrolytes satisfying a composition represented by Formula (1).

Lₐ₁M_{b1}P_{c1}S_{d1}Aₑ₁ (1)

(In the formula, L represents an element selected from Li, Na, and K and is preferably Li. M represents an element selected from B, Zn, Sn, Si, Cu, Ga, Sb, Al, and Ge. A represents I, Br, Cl, and F. a1 to e1 represent the compositional ratios among the respective elements, and a1:b1:c1:d1:e1 satisfies 1 to 12:0 to 5:1:2 to 12:0 to 10. Furthermore, a1 is preferably 1 to 9 and more preferably 1.5 to 7.5. b1 is preferably 0 to 3. Furthermore, d1 is preferably 2.5 to 10 and more preferably 3.0 to 8.5. Furthermore, e1 is preferably 0 to 5 and more preferably 0 to 3.)

The compositional ratios among the respective elements can be controlled by adjusting the amounts of raw material compounds blended to manufacture the sulfide-based solid electrolyte as described below.

The sulfide-based inorganic solid electrolytes may be non-crystalline (glass) or crystallized (made into glass ceramic) or may be only partially crystallized. For example, it is possible to use Li—P—S-based glass containing Li, P, and S or Li—P—S-based glass ceramic containing Li, P, and S.

The sulfide-based inorganic solid electrolyte can be manufactured by, for example, a reaction between at least two or more raw materials from lithium sulfide (Li₂S), phosphorus sulfide (for example, diphosphorus pentasulfide (P₂S₅5)), pure phosphorous, pure sulfur, sodium sulfide, hydrogen sulfide, halogenated lithium (for example, LiI, LiBr, and LiCl), and sulfides of the elements represented by M (for example, SiS₂, SnS, and GeS₂).

The ratio between Li₂S and P₂S₅ in Li—P—S-based glass and Li—P—S-based glass ceramic is preferably 60:40 to 90:10 and more preferably 68:32 to 78:22 in terms of the molar ratio between Li₂S:P₂S₅. In a case in which the ratio between Li₂S and P₂S₅ is set in the above-described range, it is possible to increase the lithium ion conductivity. Specifically, the lithium ion conductivity can be preferably set to 1×10⁻⁴ S/cm or more and more preferably set to 1×10⁻³ S/cm or more. The upper limit s not particularly limited, but realistically 1×10⁻¹ S/cm or less.

As specific examples of the sulfide solid electrolyte compound, combination examples of raw materials will be described below. Examples thereof include Li₂S—P₂S₅, Li₂S—P₂S₅-LiCl, Li₂S—P₂S₅—H₂S, Li₂S—P₂S₅—H₂S—LiCl, Li₂S—LiI—P₂S₅, Li₂S—LiI—Li₂O—P₂S₅, Li₂S—LiBr—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SiS₂—LiCl, Li₂S—P₂S₅—SnS, Li₂S—P₂S₅—Al₂S₃, Li₂S—GeS₂, Li₂S—GeS₂—ZnS, Li₂S—Ga₂S₃, Li₂S—GeS₂—Ge₂S₃, Li₂S—GeS₂—P₂S₅, Li₂S—GeS₂—Sb₂S₅, Li₂S—GeS₂—Al₂S₃, Li₂S—SiS₂, Li₂S—Al₂S₃, Li₂S—SiS₂—Al₂S₃, Li₂S—SiS₂—P₂S₅, Li₂S—SiS₂—P₂S₅—LiI, Li₂S—SiS₂—LiI, Li₂S—SiS₂—Li₄SiO₄, Li₂S—SiS₂—Li₃PO₄, Li₁₀GeP₂S₁₂, and the like. Here, the mixing ratio between the raw materials does not matter. Examples of a method for synthesizing sulfide-based solid electrolyte materials using the above-described raw material compositions include an amorphorization method. Examples of the amorphorization method include a mechanical milling method, a solution method, and a melting quenching method. This is because treatments at normal temperature become possible, and it is possible to simplify manufacturing steps.

(ii) Oxide-Based Inorganic Solid Electrolytes

Oxide-based inorganic solid electrolytes are preferably inorganic solid electrolytes which contain oxygen atoms (O), have an ion conductivity of metals belonging to Group I or II of the periodic table, and have electron-insulating properties.

Specific examples of the compounds include LiₓₐLa_{ya}TiO₃ [xa satisfies 0.3≦xa≦0.7 and ya satisfies 0.3≦ya≦0.7] (LLT), Li_{xb}La_{yb}Zr_{zb}M^{bb}_{mb}O_{nb} (M^{bb} is at least one element of Al, Mg, Ca, Sr, V, Nb, Ta, Ti, Ge, In and Sn, xb satisfies 5≦xb≦10, yb satisfies 1≦yb≦4, zb satisfies 1≦zb≦4, mb satisfies 0≦mb≦2, and nb satisfies 5≦nb≦20.), Li_{xc}B_{yc}M^{cc}_{zc}O_{nc} (M^{cc} is at least one of C, S, Al, Si, Ga, Ge, In, and Sn, xc satisfies 0<xc≦5, yc satisfies 0<yc≦1, zc satisfies 0≦zc≦1, and nc satisfies 0<nc≦6), Li_{xd}(Al, Ga)_{yd}(Ti, Ge)_{zd}Si_{ad}P_{md}O_{nd} (1≦xd≦3, 0≦yd≦1, 0≦xd≦2, 0≦ad≦1, 1≦md≦7, 3≦nd≦13), Li₍₃₋₂ₓₑ₎M^{ee}ₓₑD^{ee}O (xe represents a number of 0 or more and 0.1 or less, and M^{ee} represents a divalent metal atom. D^{ee} represents a halogen atom or a combination of two or more halogen atoms.), Li_{xf}Si_{yf}O_{zf} (1≦xf≦5, 0yf≦3, 1≦zf≦10), Li_{xg}S_{yg}O_{zg} (1≦xg≦3, 0yg≦2, 1≦zg≦10), Li₃BO₃—Li₂SO₄, Li₂O—B₂O₃—P₂O₅, Li₂O—SiO₂, Li₆BaLa₂Ta₂O₁₂, Li₃PO_{(4-3/2w)}N_{w} (w satisfies w<1), Li_{3.5}Zn_{0.25}GeO₄ having a lithium super ionic conductor (LISICON)-type crystal structure, La_{0.55}Li_{0.35}TiO₃ having a perovskite-type crystal structure, LiTi₂P₃O₁₂ having a natrium super ionic conductor (NASICON)-type crystal structure, Li_{(1+xh+yh)}(Al, Ga)ₓₕ(Ti, Ge)₍₂₋ₓₕ₎Si_{yh}P_{(3-yh)}O₁₂ (0≦xh≦1, 0≦yh≦1), Li₇La₃Zr₂O₁₂ (LLZ) having a garnet-type crystal structure. In addition, phosphorus compounds containing Li, P and O are also desirable. Examples thereof include lithium phosphate (Li₃PO₄), LiPON in which some of oxygen atoms in lithium phosphate are substituted with nitrogen, LiPOD¹ (D¹ is at least one selected from Ti, V Cr, Mn, Fe, Co, Ni, Cu, Zr, Nb, Mo, Ru, Ag, Ta, W, Pt, Au, and the like), and the like. It is also possible to preferably use LiA¹ON (A¹ represents at least one selected from Si, B, Ge, Al, C, Ga, and the like) and the like.

In the present invention, LiₓₐLa_{ya}TiO₃, Li_{xb}La_{yb}Zr_{zb}M^{bb}_{mb}O_{nb}, Li_{3.5}Zn_{0.25}GeO₄, LiTi₂P₃O₁₂, Li_{(1+xh+yh)}(Al, Ga)ₓₕ(Ti, Ge)₍₂₋ₓₕ₎Si_{yh}P_{(3-yh)}O₁₂, Li₃PO₄, PiPON, LiPOD¹, LiA¹ON, Li_{xc}B_{yc}M^{cc}_{zc}O_{nc}, Li₍₃₋₂ₓₑ₎M^{ee}ₓₑD^{ee}O, Li_{xf}Si_{yf}O_{zf}, and Li_{xg}S_{yg}O_{zg} are more preferred.

In addition, subsequent to the above-described compounds, lithium ion-conductive inorganic solid electrolytes represented by General Formula (SE) are preferred.

The volume-average particle diameter of the inorganic solid electrolyte is not particularly limited, but is preferably 0.01 μm or more and more preferably 0.1 μm or more. The upper limit is preferably 100 μm or less and more preferably 50 μm or less. Meanwhile, the volume-average particle diameter of the inorganic solid electrolyte is measured in the following order. One percent by mass of a dispersion liquid is prepared using the inorganic solid electrolyte and water (heptane in a case in which the inorganic solid electrolyte is unstable in water) in a 20 ml sample bottle by means of dilution. The diluted dispersion specimen is irradiated with 1 kHz ultrasonic waves for 10 minutes and is then immediately used for testing. Data capturing is carried out 50 times using this dispersion liquid specimen, a laser diffraction/scattering-type particle size distribution measurement instrument LA-920 (trade name, manufactured by Horiba Ltd.), and a silica cell for measurement at a temperature of 25° C., thereby obtaining the volume-average particle diameter. Regarding other detailed conditions and the like, the description of JIS Z8828:2013 “Particle size analysis-Dynamic light scattering method” is referred to as necessary. Five specimens are produced per level, and the average values thereof are employed.

When a decrease in interface resistance and the maintenance of the decreased interface resistance are taken into account, the concentration of the inorganic solid electrolyte in the solid component of the solid electrolyte composition is preferably 5% by mass or more, more preferably 10% by mass or more, and particularly preferably 20% by mass or more with respect to 100% by mass of the solid components. From the same viewpoint, the upper limit is preferably 99.9% by mass or less, more preferably 99.5% by mass or less, and particularly preferably 99% by mass or less.

These inorganic solid electrolytes may be used singly or two or more inorganic solid electrolytes may be used in combination.

The inorganic solid electrolyte having conductivity of ions of metals belonging to Group I or II of the periodic table that is used in all-solid state secondary batteries, active materials described below, and the like are generally fine solid particles, and, in electrode sheets for all-solid state secondary batteries or all-solid state secondary batteries, these fine particles form an assembly state. Therefore, pores are partially generated among fine particles even in a state in which the fine particles are closely packed.

In the present invention it becomes possible to decrease interface resistance between fine solid particles, between fine solid particles and the collector, and the like by filling the pores with the siloxane compound in which the salt of an ion of the metal belonging to Group I or II of the periodic table is uniformly dispersed (preferably dissolved). As a result, it is assumed that the ion conductivity of the metal belonging to Group I or II of the periodic table improves. The amount of the siloxane compound necessary to fill the pores is small, and furthermore, it is possible to enclose the entire assembly of fine particles including pores.

The content of the siloxane compound that is used in the present invention in the solid electrolyte composition of the present invention is, as described in advance, preferably 0.1% by mass or more and 60% by mass or less of all of the solid components in the solid electrolyte composition.

Meanwhile, the content is preferably 0.1 parts by mass or more and 60 parts by mass or more, more preferably 0.1 parts by mass or more and 30 parts by mass or less, still more preferably 0.1 parts by mass or more and 20 parts by mass or less, particularly preferably 0.5 parts by mass or more and 10 parts by mass or less, and most preferably 2 to 10 parts by mass with respect to 100 parts by mass of the inorganic solid electrolyte.

Meanwhile, regarding the volume relationship, the volume is preferably 0.1 volumes or more and 90 volumes or less, more preferably 0.1 volumes or more and 70 volumes or less, still more preferably 0.1 volumes or more and 50 volumes or less, particularly preferably 1 volume or more and 30 volumes or less, and most preferably 4 volumes or more and 30 volumes or less with respect to 100 volumes of the inorganic solid electrolyte. Here, the volume has a unit of, for example, cm³.

<Binder>

The solid electrolyte composition present invention preferably contains a binder.

The binder is preferably a binder other than the above-described siloxane compound and is not particularly limited as long as the binder is an organic polymer other than siloxane oligomers.

The binder that can be used in the present invention is preferably a binder that is generally used as a binding agent for positive electrodes or negative electrodes of battery materials.

In the present invention, a hydrocarbon resin, a fluororesin, an acrylic resin, or a polyurethane resin is preferred. In addition, a particulate binder is preferred.

Examples of the hydrocarbon resin include polyethylene, polypropylene, styrene butadiene rubber (SBR), hydrogenated styrene butadiene rubber (HSBR), butylene rubber, acrylonitrile butadiene rubber, polybutadiene, and polyisoprene.

Examples of the fluororesin include polytetrafluoroethylene (PTFE), polyvinylene difluoride (PVdF), and copolymers of polyvinylene difluoride and hexafluoropropylene (PVdF-HFP).

Examples of the acrylic resin include polymethyl (meth)acrylate, polyethyl (meth)acrylate, polyisopropyl (meth)acrylate, polyisobutyl (meth)acrylate, polybutyl (meth)acrylate, polyhexyl (meth)acrylate, polyoctyl (meth)acrylate, potydodecyl (meth)acrylate, polystearyl (meth)acrylate, poly 2-hydroxyethyl (meth)acrylate, poly(meth)acrylate, polybenzyl (meth)acrylate, polyglycidyl (meth)acrylate, polydimethylaminopropyl (meth)acrylate and copolymers of monomers constituting the above-described resins.

In addition, copolymers with other vinyl-based monomers are also preferably used. Examples thereof include polymethyl (meth)acrylate-polystyrene copolymers, polymethyl (meth)acrylate-acrylonitrile copolymers, and polybutyl (meth)acrylate-acrylonitrile-styrene copolymers.

Preferred examples include the binders described in Paragraphs 0029 to 0073 of JP2015-088486A.

Examples of the polyurethane resin include the polyurethane resins described in Paragraphs 0041 to 0128 of JP2015-088440A.

The binders may be used singly or two or more binders may be used in combination.

The moisture concentration of the polymer constituting the binder that is used in the present invention is preferably 100 ppm (mass-based) or less.

The mass average molecular weight of the polymer constituting the binder that is used in the present invention is preferably 10,000 or more, more preferably 20,000 or more, and still more preferably 50,000 or more. The upper limit is preferably 1,000,000 or less, more preferably 200,000 or less, and still more preferably 100,000 or less. In addition, crosslinked polymers are also preferred.

In the present invention, the molecular weight of the polymer refers to the mass average molecular weight unless particularly otherwise described. The mass average molecular weight can be measured as the polystyrene-equivalent molecular weight by means of GPC, and, specifically, is measured using the method described in examples.

In a case in which favorable interface resistance-reducing and maintaining properties are taken into account when the binder is used in all-solid state secondary batteries, the concentration of the binder in the solid electrolyte composition is preferably 0.01% by mass or more, more preferably 0.1% by mass or more, and still more preferably 1% by mass or more with respect to 100% by mass of the solid components. From the viewpoint of battery characteristics, the upper limit is preferably 10% by mass or less, more preferably 5% by mass or less, and still more preferably 3% by mass or less.

In the present invention, the mass ratio [(the mass of inorganic solid electrolyte and the mass of the electrode active materials)/the mass of the binder] of the total mass of the inorganic solid electrolyte and the electrode active materials that are added as necessary to the mass of the binder is preferably in a range of 1,000 to 1. This ratio is more preferably 500 to 2 and still more preferably 100 to 10.

(Auxiliary Conductive Agent)

Next, an auxiliary conductive agent that can be used in the solid electrolyte composition of the present invention will be described.

In the present invention, auxiliary conductive agents that are known as ordinary auxiliary conductive agents can be used. The auxiliary conductive agent may be, for example, graphite such as natural graphite or artificial graphite, carbon black such as acetylene black, Ketjen black, or furnace black, irregular carbon such as needle cokes, a carbon fiber such as a vapor-grown carbon fiber or a carbon nanotube, or a carbonaceous material such as graphene or fullerene, all of which are electron-conductive materials, and also may be metal powder or a metal fiber of copper, nickel, or the like, and a conductive macromolecule such as polyaniline, polypyrrole, polythiophene, polyacetylene, or a polyphenylene derivative may also be used. In addition, these auxiliary conductive agents may be used singly or two or more auxiliary conductive agents may he used.

(Positive Electrode Active Material)

Next, a positive electrode active material is used in the solid electrolyte composition for forming the positive electrode active material layer in the all-solid state secondary battery of the present invention (hereinafter, also referred to as the composition for a positive electrode) will be described. The positive electrode active material is preferably a positive electrode active material capable of reversibly intercalating and deintercalating lithium ions. The above-described material is not particularly limited and may be transition metal oxides, elements capable of being complexed with Li such as sulfur, or the like. Among these, transition metal oxides are preferably used, and the transition metal oxides more preferably have one or more elements selected from Co, Ni, Fe, Mn, Cu, and V as transition metal.

Specific examples of the transition oxides include transition metal oxides having a bedded salt-type structure (MA), transition metal oxides having a spinel-type structure (MB), lithium-containing transition metal phosphoric acid compounds (MC), lithium-containing transition metal halogenated phosphoric acid compounds (MD), lithium-containing transition metal silicate compounds (ME), and the like.

Specific examples of the transition metal oxides having a bedded salt-type structure (MA) include LiCoO₂ (lithium cobalt oxide [LCO]), LiNi₂O₂ (lithium nickelate), LiNi_{0.85}Co_{0.10}Al_{0.05}O₂ (lithium nickel cobalt aluminum oxide [NCA]), LiNi_{0.33}Co_{0.33}Mn_{0.33}O₂ (lithium nickel manganese cobalt oxide [NMC]), and LiNi_{0.5}Mn_{0.5}O₂ (lithium manganese nickelate).

Specific examples of the transition metal oxides having a spinel-type structure (MB) include LiCoMnO₄, Li₂FeMn₃O₈, Li₂CuMn₃O₈, Li₂CrMn₃O₈, and Li₂NiMn₃O₈.

Examples of the lithium-containing transition metal phosphoric acid compounds (MC) include olivine-type iron phosphate salts such as LiFePO₄ and Li₃Fe₂(PO₄)₃, iron pyrophosphates such as LiFeP₂O₇, cobalt phosphates such as LiCoPO₄, and monoclinic nasicon-type vanadium phosphate salt such as Li₃V₂(PO₄)₃ (lithium vanadium phosphate).

Examples of the lithium-containing transition metal halogenated phosphoric acid compounds (MD) include iron fluorophosphates such as Li₂CoPO₄F, manganese fluorophosphates such as Li₂MnPO₄F, cobalt fluorophosphates such as Li₂CoPO₄F.

Examples of the lithium-containing transition metal silicate compounds (ME) include Li₂FeSiO₄, Li₂MnSiO₄, Li₂CoSiO₄, and the like.

The volume-average particle diameter (circle-equivalent average particle diameter) of the positive electrode active material that can be used in the solid electrolyte composition of the present invention is not particularly limited. Meanwhile, the volume-average particle diameter is preferably 0.1 μm to 50 μm. In order to provide a predetermined particle diameter to the positive electrode active material, an ordinary crusher or classifier may be used. Positive electrode active materials obtained using a firing method may be used after being washed with water, an acidic aqueous solution, an alkaline aqueous solution, or an organic solvent. The volume-average particle diameter of positive electrode active material can be measured using a laser diffraction/scattering-type particle size distribution measurement instrument LA-920 (trade name, manufactured by Horiba Ltd.).

The concentration of the positive electrode active material is not particularly limited, but is preferably 10% to 90% by mass and more preferably 20% to 80% by mass with respect to 100% by mass of the solid components in the composition for a positive electrode.

The positive electrode active material may be used singly or two or more positive electrode active materials may be used in combination.

(Negative Electrode Active Material)

Next, a negative electrode active material that is used in the solid electrolyte composition for forming the negative electrode active material layer in the all-solid state secondary battery of the present invention (hereinafter, also referred to as the composition for a negative electrode) will be described. The negative electrode active material is preferably a negative electrode active material capable of reversibly intercalating and deintercalating lithium ions. The above-described material is not particularly limited, and examples thereof include carbonaceous materials, metal oxides such as tin oxide and silicon oxide, metal complex oxides, a lithium single body or lithium alloys such as lithium aluminum alloys, metals capable of forming alloys with lithium such as Sn, Si, and In and the like. Among these, carbonaceous materials or metal complex oxides are preferably used in terms of reliability. In addition, the metal complex oxides are preferably capable of absorbing and deintercalating lithium. The materials are not particularly limited, but preferably contain titanium and/or lithium as constituent components from the viewpoint of high-current density charging and discharging characteristics.

The carbonaceous material that is used as the negative electrode active material is a material substantially consisting of carbon. Examples thereof include petroleum pitch, carbon black such as acetylene black (AB), natural graphite, artificial graphite such as highly oriented pyrolytic graphite, and carbonaceous material obtained by firing a variety of synthetic resins such as polyacrylonitrile (PAN)-based resins or furfuryl alcohol resins. Furthermore, examples thereof also include a variety of carbon fibers such as PAN-based carbon fibers, cellulose-based carbon fibers, pitch-based carbon fibers, vapor-grown carbon fibers, dehydrated polyvinyl alcohol (PVA)-based carbon fibers, lignin carbon fibers, glassy carbon fibers, and active carbon fibers, mesophase microspheres, graphite whisker, flat graphite, and the like.

The metal oxides and the metal complex oxides being applied as the negative electrode active material are particularly preferably amorphous oxides, and furthermore, chalcogenides which are reaction products between a metal element and an element belonging to Group XVI of the periodic table are also preferably used. The amorphous oxides mentioned herein refer to oxides having a broad scattering band having a peak of a 20 value in a range of 20° to 40° in an X-ray diffraction method in which CuKα rays are used and may have crystalline diffraction lines. The highest intensity in the crystalline diffraction line appearing at the 20 value of 40° or more and 70° or less is preferably 100 times or less and more preferably five times or less of the diffraction line intensity at the peak of the broad scattering line appearing at the 20 value of 20° or more and 40° or less and particularly preferably does not have any crystalline diffraction lines.

In a compound group consisting of the amorphous oxides and the chalcogenides, amorphous oxides of semimetal elements and chalcogenides are more preferred, and elements belonging to Groups XIII (IIIB) to XV (VB) of the periodic table, oxides consisting of one element or a combination of two or more elements of Al, Ga, Si, Sn, Ge, Pb, Sb, and Bi, and chalcogenides are particularly preferred. Specific examples of preferred amorphous oxides and chalcogenides include Ga₂O₃, SiO, GeO, SnO, SnO₂, PbO, PbO₂, Pb₂O₃, Pb₂O₄, Pb₃O₄, Sb₂O₃, Sb₂O₄, Sb₂O₅, Bi₂O₃, SnSiO₃, GeS, SnS, SnS₂, PbS, PbS₂, Sb₂S₃, Sb₂S₅ and SnSiS₃. In addition, these amorphous oxides may be complex oxides with lithium oxide, for example, Li₂SnO₂.

The volume-average particle diameter of the negative electrode active material is preferably 0.1 μm to 60 μm. In order to provide a predetermined particle diameter, an arbitrary crusher or classifier is used. For example, a mortar, a ball mill, a sand mill, an oscillatory ball mill, a satellite ball mill, a planetary ball mill, a swirling airflow-type jet mill, a sieve, or the like is preferably used. During crushing, it is also possible to carry out wet-type crushing in which water or an organic solvent such as methanol is made to coexist as necessary. In order to provide a desired particle diameter, classification is preferably carried out. The classification method is not particularly limited, and it is possible to use a sieve, a wind power classifier, or the like depending on the necessity. Both of dry-type classification and wet-type classification can be carried out. The volume-average particle diameter of negative electrode active material particles can be measured using the same method as the method for measuring the volume-average particle diameter of the positive electrode active material.

The negative electrode active material also preferably contains titanium atoms. More specifically, Li₄Ti₅O₁₂ is preferred since the volume fluctuation during the absorption and emission of lithium ions is small and thus the high-speed charging and discharging characteristics are excellent and the deterioration of electrodes is suppressed, whereby it becomes possible to improve the service lives of lithium ion secondary batteries.

The concentration of the negative electrode active material is not particularly limited, but is preferably 10 to 90% by mass and more preferably 20 to 80% by mass with respect to 100% by mass of the solid components in the composition for a negative electrode.

The negative electrode active material may be used singly or two or more negative electro active materials may be used in combination.

(Dispersion Medium)

The solid electrolyte composition of the present invention preferably contains a dispersion medium. The dispersion medium needs to be capable of dispersing the respective components described above, and specific examples thereof include the following media.

Examples of alcohol compound solvents include methyl alcohol, ethyl alcohol, 1-propyl alcohol, 2-propyl alcohol, 2-butanol, ethylene glycol, propylene glycol, glycerin, 1,6-hexanediol, cyclohexanediol, sorbitol, xylitol, 2-methyl-2,4-pentanediol, 1,3-butanediol, and 1,4-butanediol.

Examples of ether compound solvents include alkylene glycol alkyl ethers (ethylene glycol monomethyl ether, ethylene glycol monobutyl ether, diethylene glycol, dipropylene glycol, propylene glycol monomethyl ether, diethylene glycol monomethyl ether, triethylene glycol, polyethylene glycol, propylene glycol monomethyl ether, dipropylene glycol monomethyl ether, tripropylene glycol monomethyl ether, diethylene glycol monobutyl ether, and the like), dimethyl ether, diethyl ether, diisopropyl ether, dibutyl ether, tetrahydrofuran, and dioxane.

Examples of amide compound solvents N,N-dimethylformamide, 1-methyl-2-pyrrolidone, 2-pyrrolidone, 1,3-dimethyl-2-imidazolidinone, ε-caprolactam, formamide, N-methylformamide, acetamide, N-methylacetamide, N,N-dimethylacetamide, N-methylpropanamide, and hexamethylphosphoric triamide.

Examples of amino compound solvents include triethylamine, diisopropylethylamine, and tributylamine.

Examples of ketone compound solvents include acetone, methyl ethyl ketone, methyl isobutyl ketone, and cyclohexanone.

Examples of aromatic compound solvents include benzene, toluene, and xylene.

Examples of aliphatic compound solvents include hexane, heptane, octane, and decane.

Examples of nitrile compound solvents include acetonitrile, propionitrile, and butyronitrile.

The boiling point of the dispersion medium at normal sure (one atmosphere) is preferably 30° C. or higher and more preferably 50° C. or higher. The upper limit is preferably 250° C. or lower and more preferably 220° C. or lower.

In a case in which the boiling point is in the above-described preferred range, in the production of the all-solid state secondary battery, it is possible to dry the dispersion medium while maintaining the structure of the self-assembly nanofibers. Meanwhile, even in a case in which a dispersion medium having a boiling point that is equal to or higher than the drying temperature, the dispersion medium needs to be volatile and be capable of maintaining the structure of the self-assembly nanofibers.

The dispersion medium may be used singly or two or more dispersion media may be used in combination.

In the present invention, examples of the dispersion medium include the aromatic compound solvents, the aliphatic compound solvents, the ether compound solvents, the amide compound solvents, and the ketone compound solvents. Specifically, toluene, heptane, octane, dibutyl ether, 1-methyl-2-pyrrolidone, and methyl ethyl ketone are preferably used.

The content of the dispersion medium is preferably 10 to 90 parts by mass, more preferably 20 to 80 parts by mass, and still more preferably 30 to 70 parts by mass in 100 parts by mass of the total mass of the solid electrolyte composition.

<Collector (Metal Foil)>

The collectors of positive and negative electrodes are preferably electron conductors. The collector of the positive electrode is preferably a collector obtained by treating the surface of an aluminum or stainless steel collector with carbon, nickel, titanium, or silver in addition to an aluminum collector, a stainless steel collector, a nickel collector, a titanium collector, or the like, and, among these, an aluminum collector and an aluminum alloy collector are more preferred. The collector of the negative electrode is preferably an aluminum collector, a copper collector, a stainless steel collector, a nickel collector, or a titanium collector and more preferably an aluminum collector, a copper collector, or a copper alloy collector.

Regarding the shape of the collector, generally, collectors having a film sheet-like shape are used, but it is also possible to use net-shaped collectors, punched collectors, compacts of lath bodies, porous bodies, foaming bodies, or fiber groups, and the like.

The thickness of the collector is not particularly limited, but is preferably 1 μm to 500 μm. In addition, the surface of the collector is preferably provided with protrusions and recesses by means of a surface treatment.

<Production of All-Solid State Secondary Battery>

The all-solid state secondary battery may be produced using an ordinary method. Specific examples thereof include a method in which the solid electrolyte composition of the present invention is applied onto a metal foil which serves as the collector, thereby producing an electrode sheet for an all-solid state secondary battery on which a coated film is formed.

In the all-solid state secondary battery of the present invention, the electrode layers contain active materials. From the viewpoint of improving ion conductivity, the electrode layers preferably contain the inorganic solid electrolyte. In addition, from the viewpoint of improving the bonding properties between the electrode layers and solid particles, between the electrode layers and the solid electrolyte layer, and between the electrode and the collector, the electrode layers also preferably contain the binder.

Meanwhile, the solid electrolyte layer is formed of the solid electrolyte composition of the present invention,

[Usages of All-Solid State Secondary battery]

The all-solid state secondary battery of the present invention can be applied to a variety of usages. Application aspects are not particularly limited, and, in the case of being mounted in electronic devices, examples thereof include notebook computers, pen-based input personal computers, mobile personal computers, e-book players, mobile phones, cordless phone handsets, pagers, handy terminals, portable faxes, mobile copiers, portable printers, headphone stereos, video movies, liquid crystal televisions, handy cleaners, portable CDs, mini discs, electric shavers, transceivers, electronic notebooks, calculators, portable tape recorders, radios, backup power supplies, memory cards, and the like. Additionally, examples of consumer usages include automobiles, electric vehicles, motors, lighting equipment, toys, game devices, road conditioners, watches, strobes, cameras, medical devices (pacemakers, hearing aids, shoulder massage devices, and the like), and the like. Furthermore, the all-solid state secondary battery can be used for a variety of military usages and universe usages. In addition, the all-solid state secondary battery can also be combined with solar batteries.

Among these, the all-solid state secondary battery is preferably applied to applications for which a high capacity and high-rate discharging characteristics are required. For example, in electricity storage facilities in which an increase in the capacity is expected in the future, it is necessary to satisfy both high safety, which is essential, and furthermore, the battery performance. In addition, in electric vehicles mounting high-capacity secondary batteries and domestic usages in which batteries are charged out every day, better safety is required against overcharging. According to the present invention, it is possible to preferably cope with the above-described use aspects and exhibit excellent effects.

According to the preferred embodiment of the present invention, individual application forms as described below are derived.

[1] Solid electrolyte compositions including active materials capable of intercalating and deintercalating ions of metals belonging to Group I or II of the periodic table (compositions for an electrode that is a positive electrode or negative electrode).

[2] Electrode sheets for an all-solid state secondary battery having a positive electrode active material layer, a solid electrolyte layer, and a negative electrode active material layer in this order, in which the positive electrode active material layer, the solid electrolyte layer, and the negative electrode active material layer contain an inorganic solid electrolyte having conductivity of ions of metals belonging to Group I or II of the periodic table, a siloxane compound having a siloxane bond in a branched shape, and a salt of an ion of a metal belonging to Group I or II of the periodic table.

[3] All-solid state secondary batteries constituted using the above-described electrode sheet for an all-solid state-secondary battery.

[4] Methods for manufacturing an electrode sheet for an all-solid state secondary battery in which the solid electrolyte composition is applied onto a metal foil, thereby forming a film.

[5] Methods for manufacturing an all-solid state secondary battery in which all-solid state secondary batteries are manufactured using the method for manufacturing an all-solid state secondary battery.

Meanwhile, examples of the methods in which the solid electrolyte composition is applied onto a metal foil include coating (wet-type coating, spray coating, spin coating, slit coating, stripe coating, bar coating, or dip coating), and wet-type coating is preferred.

All-solid state secondary batteries refer to secondary batteries having a positive electrode, a negative electrode, and an electrolyte which are all constituted of solid. In other words, all-solid state secondary batteries are differentiated from electrolytic solution-type secondary batteries in which a carbonate-based solvent is used as an electrolyte. Among these, the present invention is assumed to be an inorganic all-solid state secondary battery. All-solid state secondary batteries are classified into organic (high-molecular-weight) all-solid state secondary batteries in which a high-molecular-weight compound such as polyethylene oxide is used as an electrolyte and inorganic all-solid state secondary batteries in which the Li—P—S-based glass, LLT, LLZ, or the like is used. Meanwhile, the application of high-molecular-weight compounds to inorganic all-solid state secondary batteries is not inhibited, and high molecular-weight compounds can also be applied as binders of positive electrode active materials, negative electrode active materials, and inorganic solid electrolytes.

Inorganic solid electrolytes are differentiated from electrolytes in which the above-described high-molecular-weight compound is used as an ion conductive medium (high-molecular-weight electrolyte), and inorganic compounds serve as ion conductive media. Specific examples thereof include the Li—P—S glass, LLT, and LLZ. Inorganic solid electrolytes do not emit positive ions (Li ions) and exhibit art ion transportation function. In contrast, there are cases in which materials serving as an ion supply source which is added to electrolytic solutions or solid electrolyte layers and emits positive ions (Li ions) are referred to as electrolytes; however, in the case of being differentiated from electrolytes as the ion transportation materials, the materials are referred to as “electrolyte salts” or “supporting electrolytes”, Examples of the electrolyte salts include LiTFSI.

In the present invention, “compositions” refer to mixtures obtained by uniformly mixing two or more components. Here, compositions may partially include agglomeration or uneven distribution as long as the compositions substantially maintain uniformity and exhibit desired effects.

### EXAMPLES

Hereinafter, the present invention will be described in more detail on the basis of examples. Meanwhile, the present invention is not interpreted to be limited thereto. In the following examples, “parts” and “%” are mass-based unless particularly otherwise described.

Meanwhile, mass average molecular weights refer to mass average molecular weights in terms of standard polystyrene measured by means of get permeation chromatography (GPC).

A measurement instrument and measurement conditions will be described below.

### Instrument and Conditions For Measuring Mass Average Molecular Weight

Regarding the measurement instrument and the measurement conditions, the following conditions 2 were basically applied, and the conditions 1 were applied depending on the solubility of specimens and the like. However, depending on the kinds of polymers, more appropriate carriers (eluents) columns suitable for the carriers were selected.

(Conditions 1)

Column: Two TOSOH TSKgel Super AWM-H (trade name, manufactured by Tosoh Corporation) were connected to each other.

Carrier: 10 mM LiBr/N-methyl pyrrolidone

Measurement temperature: 40° C.

Carrier flow rate: 1.0 ml/min

Specimen concentration: 0.1% by mass

Detector: RI (refractive index) detector

(Conditions 2)

Column: A column produced by connecting TOSOH TSKgel Super HZM-H, TOSOH TSKgel Super HZ4000, and TOSOH TSKgel Super HZ2000 (all are trade names, manufactured by Tosoh Corporation) was used.

Carrier: Tetrahydrofuran

Measurement temperature: 40° C.

Carrier flow rate: 1.0 ml/min

Specimen concentration: 0.1% by mass

Detector: RI (refractive index) detector

### Example 1

A siloxane compound having a siloxane bond in a branched shape, a binder, and a sulfide-based inorganic solid electrolyte that were to be used in examples were synthesized or prepared.

### Synthesis of Siloxane Compound Having Siloxane Bond in Branched Shape

(1) Synthesis of Siloxane Oligomer (Si-2)

Tetraethoxysilane (manufactured by Wako Pure Chemical Industries, Ltd.) (17.0 g) and glycolic acid (manufactured by Wako Pure Chemical Industries, Ltd.) (3.00 g) were mixed together and were heated and refluxed at 150° C. for one hour. After a reaction, the temperature was maintained at 150° C., and volatile components were distilled while slowly decreasing the degree of vacuum from normal pressure to 5 mmHg, thereby obtaining a siloxane oligomer (Si-2) (6.23 g) as a white liquid. The mass average molecular weight in terms of styrene measured by means of GPC measurement was 2,400. It was confirmed by means of Si-NMR that the siloxane oligomer had a branched structure. In addition, the mole fraction of a group corresponding to (—O-L²¹-CO₂R²¹) represented by General Formula (1s), which was included as a partial structure, in the oligomer was measured by means of ¹H-NMR and was found out to be 34 mol %.

(2) Synthesis of Siloxane Oligomer (Si-1)

A siloxane oligomer (Si-1) was synthesized as a white liquid in the same manner as in the synthesis of the siloxane oligomer (Si-2) except for the fact that the amount of the glycolic acid added was changed in the synthesis of the siloxane oligomer (Si-2). The mass average molecular weight in terms of styrene measured by means of GPC measurement was 2,600. It was confirmed by means of Si-NMR that the siloxane oligomer had a branched structure. In addition, the mole fraction of a group corresponding to (—O-L²¹-CO₂R²¹) represented by General Formula (1s), which was included as a partial structure, in the oligomer was measured by means of ¹H-NMR and was found out to be 14 mol %.

(3) Synthesis of Siloxane Oligomer (Si-3)

A siloxane oligomer (Si-3) was synthesized as a white liquid in the same manner as the synthesis of the siloxane oligomer (Si-2) except for the fact that the tetraethoxysilane was changed to tetraisopropoxysilane (manufactured by Tokyo Chemical Industry Co., Ltd.) in the synthesis of the siloxane oligomer (Si-2). The mass average molecular weight in terms of styrene measured by means of GPC measurement was 1,900. It was confirmed by means of Si-NMR that the siloxane oligomer had a branched structure. In addition, the mole fraction of a group corresponding to (—O-L²¹-CO₂R²¹)represented by General Formula (1s), which was included as a partial structure, in the oligomer measured means of ¹H-NMR and was found out to be 39 mol %.

(4) Synthesis of Siloxane Oligomer (Si-4)

A siloxane oligomer (Si-4) was synthesized as a white liquid in the same manner as in the synthesis of the siloxane oligomer (Si-2) except for the fact that, in the synthesis of the siloxane oligomer (Si-2), the glycolic acid was changed to ethyl glycolate (manufactured by Tokyo Chemical Industry Co., Ltd.), and acetic acid (manufactured by Tokyo Chemical Industry Co., Ltd.) (0.1 g) was added thereto as an acid catalyst. The mass average molecular weight in terms of styrene measured by means of GPC measurement was 1,300. It was confirmed by means of Si-NMR that the siloxane oligomer had a branched structure. In addition, the mole fraction of a group corresponding to (—O-L²¹-CO₂R²¹) represented by General Formula (1s), which was included as a partial structure, in the oligomer was measured by means of ¹H-NMR and was found out to be 26 mol %.

(5) Synthesis of Siloxane Oligomer (Si-5)

A siloxane oligomer (Si-5) was synthesized as a white liquid in the same manner as in the synthesis of the siloxane oligomer (Si-2) except for the fact that the tetraethoxysilane was changed to methyltriethoxysilane (manufactured by Tokyo Chemical Industry Co., Ltd.) in the synthesis of the siloxane oligomer (Si-2). The mass average molecular weight in terms of styrene measured by means of GPC measurement was 1,500. It was confirmed by means of Si-NMR that the siloxane oligomer had a branched structure. In addition, the mole fraction of a group corresponding to (—O-L²¹-CO₂R²¹) represented by General Formula (1s), which was included as a partial structure, in the oligomer was measured by means of ¹H-NMR and was found out to be 29 mol %.

TABLE 1

| Siloxane | | | Mole fraction of group of | |
|---|---|---|---|---|
| oligomer No. | M1 | M2 | General Formula (1s) (%) | Mw |
| Si-1 | A-2 | a-1 | 14 | 2,600 |
| Si-2 | A-2 | a-1 | 34 | 2,400 |
| Si-3 | A-4 | a-1 | 39 | 1,900 |
| Si-4 | A-2 | a-7 | 26 | 1,300 |
| Si-5 | A-6 | a-1 | 29 | 1,500 |

<Notes of table>
M1: The kind of the alkoxysilane compound as the raw material
M2: The kind of hydroxycarboxilic acid or an ester compound thereof

### Preparation of Binder

(1) Preparation of Binder (B-1)

(a) Synthesis of Macromonomer (M-1)

Toluene (190 parts by mass) was added to a 1 L three-neck flask equipped with a reflux cooling pipe and a gas introduction coke, nitrogen gas was introduced thereinto at a flow rate of 200 mL/min for ten minutes, and then the temperature was increased to 80° C. A liquid mixture A prepared in a separate container according to the following formulation was added dropwise thereto for two hours and then stirred 80° C. for two hours. After that, V-601 (0.2 g) was added thereto and, furthermore, stirred at 95° C. for two hours. After the stirring, 2,2,6,6-tetramethylpiperidine-1oxyl (manufactured by Tokyo Chemical Industry Co., Ltd.) (0.025 parts by mass), glycidyl methacrylate (manufactured by Wako Pure Chemical Industries, Ltd.) (13 parts by mass and tetrabutyl ammonium bromide (manufactured by Tokyo Chemical Industry Co., Ltd.) (2.5 parts by mass) were added to the reaction solution maintained at 95° C. and were stirred in the atmosphere at 120° C. for three hours. After the mixture was cooled to room temperature, methanol was added thereto and precipitated, the generated precipitate was washed twice with methanol and dried by blowing the air at 50° C. The obtained solid was dissolved in heptane (300 parts by mass), thereby obtaining a solution of a macromonomer (M-1) (hereinafter, referred to as the heptane solution of a monomer). The solid content concentration of the macromonomer (M-1) was 43.4% by mass, the mass average molecular weight was 16,000, and the SP value which is a solution parameter, was 9.1.

(Formulation of Liquid Mixture A)

Dodecyl methacrylate (manufactured by Wako Pure Chemical Industries, Ltd.) 150 parts by mass

Methyl methacrylate (manufactured by Wako Pure Chemical Industries, Ltd.) 59 parts by mass

3-Mercaptoisobutyric (manufactured by Tokyo Chemical Industry Co., Ltd)) 2 parts by mass

V-601 (manufactured by Wako Pure Chemical Industries, Ltd) 1.9 parts by mass

(b) Synthesis of Binder (B-1)

The heptane solution of a monomer prepared above (47 parts by mass) and heptane (60 parts by mass) were added to a 1 L three-neck flask equipped with a reflux cooling tube and a gas introduction coke, nitrogen gas was introduced thereinto at a flow rate of 200 mL/min for ten minutes, and then the temperature was increased to 80° C. A liquid mixture B [a liquid mixture of the heptane solution of a monomer prepared above (93 parts by mass), butyl acrylate (manufactured by Wako Pure Chemical Industries, Ltd.) (100 parts by mass), methyl methacrylate (manufactured by Wako Pure Chemical Industries, Ltd.) (20 parts by mass), acrylic acid (manufactured by Wako Pure Chemical Industries, Ltd.) (20 parts by mass), and V-601 (manufactured by Wako Pure Chemical Industries, Ltd.) (1.1 parts by mass)] prepared in a separate container was added dropwise thereto for two hours and then stirred at 80° C. for two hours. After that, V-601 (0.2 g) was added thereto and, furthermore, stirred at 95° C. for two hours. After the mixture was cooled to room temperature, heptane (300 mL) was added thereto, and filtering was carried out, thereby obtaining a dispersion liquid of a binder (B-1).

### Synthesis of Sulfide-Based Inorganic Solid Electrolyte (Li—P—S)

In a globe box under an argon atmosphere (dew point: −70° C.), lithium sulfide (Li₂S, manufactured by Aldrich-Sigma, Co. LLC. Purity: >99.98%) (2.42 g) and diphosphorus pentasulfide (P₂S₅, manufactured by Aldrich-Sigma, Co, LLC. Purity: >99%) (3.90 g) were respectively weighed, injected into a mortar. The molar ratio between Li₂S and P₂S₅ was 75:25 (Li₂S:P₂S₅). In the agate mortar, the components were mixed using an agate muddle for five minutes.

Zirconia beads having a diameter of 5 mm (66 g) were injected into a 45 mL zirconia container (manufactured by Fritsch Japan Co., Ltd.), the full amount of the mixture of the lithium sulfide and the diphosphorus pentasulfide was injected thereinto, and the container was completely sealed in an argon atmosphere. The container was set in a planetary ball mill P-7 (trade name) manufactured by Fritsch Japan Co., Ltd., mechanical milling was carried out at 25° C. and a rotation speed of 510 rpm for 20 hours, thereby obtaining yellow powder (6.20 g) of a sulfide-based inorganic solid electrolyte material (L—P—S glass).

Hereinafter, the respective siloxane oligomers synthesized above were mixed with a lithium salt, thereby preparing mixing additives.

### Preparation of Mixing Additives

(1) Preparation of Mixing Additive (E-4)

Lithium bis(trifluoromethanesulfonyl)imide (hereinafter, abbreviated as LiTESI) (0.9 g) was dissolved in the siloxane oligomer (Si-2) (2.1 g), thereby preparing a mixing additive (E-4).

(2) Preparation of Mixing Additives (E-1) to (E-3), (E-5) to (E-8), (EC-1) and (EC-2)

Mixing additives (E-1) to (E-3), (E-5) to (E-8), (EC-1) and (EC-2) were prepared in the same manner as the mixing additive (E-4) by changing the siloxane oligomer (Si-2) and LiTFSI siloxane oligomers or comparative compounds thereof shown in Table 2 and Li salts and contents thereof.

In Table 2, the solid content has a unit of % by mass with respect to 100 parts by mass of all of the solid contents. In addition, “-” indicates that the corresponding component is not used or included (0% by mass).

TABLE 2

| | Additives such as | | | | |
|---|---|---|---|---|---|
| Mixing | siloxane oligomer | | Li salt | | |
| additive No. | Kind | Content | Kind | Content | Remark |
| E-1 | Si-1 | 70% | LiTFSI | 30% | Present |
| | | | | | Invention |
| E-2 | Si-2 | 90% | LiTFSI | 10% | Present |
| | | | | | Invention |
| E-3 | Si-2 | 80% | LiTFSI | 20% | Present |
| | | | | | Invention |
| E-4 | Si-2 | 70% | LiTFSI | 30% | Present |
| | | | | | Invention |
| E-5 | Si-2 | 70% | LiClO₄ | 30% | Present |
| | | | | | Invention |
| E-6 | Si-3 | 70% | LiTFSI | 30% | Present |
| | | | | | Invention |
| E-7 | Si-4 | 70% | LiTFSI | 30% | Present |
| | | | | | Invention |
| E-8 | Si-5 | 70% | LiTFSI | 30% | Present |
| | | | | | Invention |
| EC-1 | IL | 70% | LiTFSI | 30% | Comparative |
| | | | | | Example |
| EC-2 | Si-2 | 100% | — | — | Comparative |
| | | | | | Example |

<Notes of table>
IL: 1-Butyl-2,3-dimethylimidazolium bis(trifluoromethanesulfonyl)imide
LiTFSI: Lithium bis(trifluoromethanesulfonyl)imide

### Preparation of Solid Electrolyte Composition

(1) Preparation of Solid Electrolyte Composition (S-6)

180 zirconia beads having a diameter of 5 mm were injected into a 45 mL zirconia container (manufactured by Fritsch Japan Co., Ltd.), and Li₇La₃Zr₂O₁₂ (hereinafter, abbreviated as LLZ) (4.8 g) as a solid electrolyte, the mixing additive (E-4) (0.15 g), the binder (B-1) synthesized in the above-described manner (0.05 g in terms of the mass of the solid content), and butane (17.0 g) as a dispersion medium were injected thereinto. After that, the container was set in a planetary ball mill manufactured by Fritsch Japan Co., Ltd., and the components were continuously mixed at a rotation speed of 100 rpm for one hour, thereby preparing a solid electrolyte composition (S-6).

(2) Preparation of Solid Electrolyte Compositions (S-1) to (S-5), (S-7) to (S-15) and (T-1) to (T-3)

Solid electrolyte compositions (S-1) to (S-5), (S-7) to (S-15), and (T-1) to (T-3) were prepared in the same manner as the solid electrolyte composition (S-6) according to the combinations shown in Table 3.

In Table 3, the content has a unit of % by mass with respect to 100 parts by mass of all of the solid components. In addition, “-” indicates that the corresponding component is not used or included (0% by mass).

In addition, the content of siloxane is the content of the siloxane compound.

TABLE 3

| Solid | | | | | | | | | |
|---|---|---|---|---|---|---|---|---|---|
| electrolyte | | | Mixing additive | | | | | | |
| composition | Solid electrolyte | | | | Content of | Binder | | Dispersion | |
| No. | Kind | Content | Kind | Content | siloxane | Kind | Content | medium | Remark |
| S-1 | LLZ | 96% | E-1 | 3% | 2.1% | B-1 | 1% | Heptane | Present |
| | | | | | | | | | Invention |
| S-2 | LLZ | 96% | E-2 | 3% | 2.7% | B-1 | 1% | Heptane | Present |
| | | | | | | | | | Invention |
| S-3 | LLZ | 96% | E-3 | 3% | 2.4% | B-1 | 1% | Heptane | Present |
| | | | | | | | | | Invention |
| S-4 | LLZ | 97% | E-4 | 3% | 2.1% | — | — | Heptane | Present |
| | | | | | | | | | Invention |
| S-5 | LLZ | 98% | E-4 | 1% | 0.7% | B-1 | 1% | Heptane | Present |
| | | | | | | | | | Invention |
| S-6 | LLZ | 96% | E-4 | 3% | 2.1% | B-1 | 1% | Heptane | Present |
| | | | | | | | | | Invention |
| S-7 | LLZ | 89% | E-4 | 10% | 7.0% | B-1 | 1% | Heptane | Present |
| | | | | | | | | | Invention |
| S-8 | LLZ | 96% | E-4 | 3% | 2.1% | B-2 | 1% | Heptane | Present |
| | | | | | | | | | Invention |
| S-9 | LLZ | 96% | E-4 | 3% | 2.1% | B-3 | 1% | Heptane | Present |
| | | | | | | | | | Invention |
| S-10 | LLT | 96% | E-4 | 3% | 2.1% | B-1 | 1% | Heptane | Present |
| | | | | | | | | | Invention |
| S-11 | Li—P—S | 96% | E-4 | 3% | 2.1% | B-1 | 1% | Heptane | Present |
| | | | | | | | | | Invention |
| S-12 | LLZ | 96% | E-5 | 3% | 2.1% | B-1 | 1% | Heptane | Present |
| | | | | | | | | | Invention |
| S-13 | LLZ | 96% | E-6 | 3% | 2.1% | B-1 | 1% | Heptane | Present |
| | | | | | | | | | Invention |
| S-14 | LLZ | 96% | E-7 | 3% | 2.1% | B-1 | 1% | Heptane | Present |
| | | | | | | | | | Invention |
| S-15 | LLZ | 96% | E-8 | 3% | 2.1% | B-1 | 1% | Heptane | Present |
| | | | | | | | | | Invention |
| T-1 | Li—P—S | 20% | EC-1 | 80% | 0% | — | — | MEK | Comparative |
| | | | | | | | | | Example |
| T-2 | LLZ | 97% | EC-2 | 3% | 3% | — | — | Heptane | Comparative |
| | | | | | | | | | Example |
| T-3 | LLZ | 98% | — | — | 0% | BC-1 | 2% | Toluene | Comparative |
| | | | | | | | | | Example |

<Notes of table>
(Solid electrolyte)
LLZ: Li₇La₃Zr₂O₁₂
LLT: Li_{0.33}La_{0.55}TiO₃
Li—P—S: The sulfide-based inorganic solid electrolyte synthesized above
(Binder)
B-1: The binder synthesized above
B-2: Hydrogenated styrene-butadiene rubber (manufactured by JSR Corporation, trade name: DYNARON1321P)
B-3: Polyvinylidene difluroride (manufactured by Arkema K. K., trade name: KYNAR301F)
BC-1: Both terminal-modified silicone (manufactured by Shin-Etsu Chemical Co., Ltd., trade name: X-22-163B)
(Dispersion medium)
MEK: Methyl ethyl ketone

### Production of Solid Electrolyte Sheet

The solid electrolyte composition (S-1) was applied onto a 20 μm-thick aluminum foil using an applicator having an adjustable clearance, heated at 80° C. for one hour, and then further heated at 120° C. for one hour, thereby drying the dispersion medium. After that, a solid electrolyte layer was heated (at 80° C.) and pressurized (60 MPa for one minute) using a heat pressing machine, thereby obtaining a solid electrolyte sheet of Test No. 101. The film thickness of the solid electrolyte layer was 50 μm.

Solid electrolyte sheets of Test Nos. 102 to 115 and c11 to 13 were produced in the same manner as the solid electrolyte sheet of Test No. 101 except for the fact that the solid electrolyte composition (S-1) was chanted to the solid electrolyte compositions shown in Table 4.

For the solid electrolyte sheets made of each of the solid electrolytes produced above, the bonding property, the ion conductivity, and the transport number were evaluated.

(1) Evaluation of Bonding Property

CELLOTAPE (registered trademark, manufactured by Nichiban Co., Ltd.) having a width of 12 mm and a length of 60 mm was adhered to the solid electrolyte layer (50 mm×12 mm) in the solid electrolyte sheet produced above and was peeled off 50 mm at a rate of 10 mm/min. The ratio of the area of the peeled sheet portion to the area of the peeled CELLOTAPE at this time was evaluated. Measurement was carried out ten times, and the average of eight measurement values excluding the maximum value and the minimum value was employed. The average value of five samples for testing used for each level was employed.

The obtained values were evaluated using the following evaluation standards.

(Evaluation Standards)

5: 0 or more and less than 5%

4: 5% or more and less than 15%

3: 15% or more and less than 30%

2: 30% or more and less than 60%

1: 60% or more

(2) Measurement of Ion Conductivity

A disc-shaped piece having a diameter of 14.5 mm was cut out from the solid electrolyte sheet produced above and put into a coin case. An aluminum foil cut out to a disc shape having a diameter of 15 mm was brought into contact with the solid electrolyte layer, a spacer and a washer were combined thereinto, and the piece was put into a stainless steel 2032-type coin case. As illustrated in FIG. 2, a confining pressure (a screw-fastening pressure: 8 N) was applied from the outside of the coin case, and cell for measuring ion conductivity was produced.

Meanwhile, in the present measurement, in FIG. 2 which is a reference, reference sign 14 indicates the coin case, reference sign 15 indicates the solid electrolyte sheets made of the solid electrolyte, reference sign 11 indicates an upper portion-supporting plate, reference sign 12 indicates a lower portion-supporting plate, and reference sign S indicates a spring.

The ion conductivity was measured using the cell for measuring ion conductivity obtained above. Specifically, alternating-current impedance was measured in a constant-temperature tank (30° C.) using a 1255B FREQUENCY RESPONSE ANALYZER (trade name) manufactured by Solartron Analytical at a voltage amplitude of 5 mV and a frequency in a range of 1 MHz to 1 Hz. As a result, the resistance of the specimen in the film thickness direction was obtained, and the ion conductivity was obtained from the following calculation expression.

Ion Conductivity (mS/cm)=1,000×the specimen film thickness (cm) of the/(the resistance (Ω)×the area (cm²)of the specimen)

(3) Measurement of Transport Number

A disc-shaped piece having a diameter of 14.5 mm was cut out from the solid electrolyte sheet produced above and put into a coin case. An aluminum foil cut out to a disc shape having a diameter of 15 mm was brought into contact with both surfaces of the solid electrolyte sheet, a spacer and a washer were combined thereinto, and the piece was put into a stainless steel 2032-type coin case. In the same manner as in the production of the cell for measuring ion conductivity, a confining pressure (a screw-fastening pressure: 8 N) was applied from the outside of the coin case, and a cell for measuring the transport number was produced.

Using each of the cells for measuring the transport number produced above, alternating-current impedance was measured in a constant-temperature tank (30° C.) using a 1255B FREQUENCY RESPONSE ANALYZER (trade name) manufactured by Solartron Analytical at a voltage amplitude of 5 mV and a frequency in a range of 1 MHz to 1 Hz, the interface resistance Rᵢ⁰ was computed, then, in the constant-temperature tank (30° C.), a direct-current voltage of 50 mV[=ΔV] was applied using a 1470-type multistate manufactured by Solartron Analytical and the initial current I₀ and the current after two hours I₂ were obtained. After that, alternating-current impedance was measured again, thereby obtaining the interface resistance Rᵢ². The transport number T₊ was computed from the following calculation expression using the obtained values.

Transport number T₊=(ΔV/I⁰−Rᵢ⁰)/(ΔV/I²−Rᵢ²)

The obtained value was evaluated using the following evaluation standards.

(Evaluation Standards)
5: 0.6≦T₊
4: 0.4≦T₊<0.6
3: 0.2≦T₊<0.4
2: 0≦T₊<0.2
1: Not measurable

The obtained results are summarized in Table 4.

TABLE 4

| | Solid | | Ion | | |
|---|---|---|---|---|---|
| Test | electrolyte | Bonding | conductivity | Transport | |
| No. | composition | property | (mS/cm) | number | Remark |
| 101 | S-1 | 4 | 0.12 | 4 | Present |
| | | | | | Invention |
| 102 | S-2 | 4 | 0.11 | 4 | Present |
| | | | | | Invention |
| 103 | S-3 | 4 | 0.14 | 4 | Present |
| | | | | | Invention |
| 104 | S-4 | 1 | 0.18 | 5 | Present |
| | | | | | Invention |
| 105 | S-5 | 4 | 0.14 | 5 | Present |
| | | | | | Invention |
| 106 | S-6 | 4 | 0.2 | 5 | Present |
| | | | | | Invention |
| 107 | S-7 | 4 | 0.17 | 4 | Present |
| | | | | | Invention |
| 108 | S-8 | 5 | 0.11 | 5 | Present |
| | | | | | Invention |
| 109 | S-9 | 3 | 0.18 | 5 | Present |
| | | | | | Invention |
| 110 | S-10 | 4 | 0.23 | 5 | Present |
| | | | | | invention |
| 111 | S-11 | 4 | 0.64 | 5 | Present |
| | | | | | Invention |
| 112 | S-12 | 4 | 0.19 | 5 | Present |
| | | | | | Invention |
| 113 | S-13 | 4 | 0.19 | 5 | Present |
| | | | | | Invention |
| 114 | S-14 | 4 | 0.18 | 5 | Present |
| | | | | | Invention |
| 115 | S-15 | 4 | 0.19 | 5 | Present |
| | | | | | Invention |
| c11 | T-1 | 1 | 0.12 | 2 | Comparative |
| | | | | | Example |
| c12 | T-2 | 1 | Not | 1 | Comparative |
| | | | measurable | | Example |
| c13 | T-3 | 2 | Not | 1 | Comparative |
| | | | measurable | | Example |

As is clear from Table 4, it is found that all of the solid electrolyte sheets manufactured using the solid electrolyte composition of the present invention had high and excellent transport number and ion conductivity. In addition, from the comparison between Test Nos. 101 to 115 and Test Nos. c11 to c13, it is found that, in a case in which the solid electrolyte sheets contained the siloxane compound having a siloxane bond in a branched shape and the salt of an ion of the metal belonging to Group I or II of the periodic table, the effect of being excellent in terms of both the transport number and the ion conductivity was exhibited. Furthermore, the solid electrolyte sheets of Test Nos. 101 to 103 and 105 to 115 for which the binder was added to the solid electrolyte composition exhibited a favorable bonding property as well as the favorable transport number and the favorable ion conductivity.

### Example 2

Electrode sheets for an all-solid state secondary battery and all-solid state secondary batteries were produced in the following manner.

### Preparation of Composition For Positive Electrode of Secondary Battery

(1) Preparation of a Composition For a Positive Electrode of a Secondary Battery in Test No. 201

180 zirconia beads having a diameter of 5 mm were injected into a 45 mL zirconia container (manufactured by Fritsch Japan Co., Ltd.), and NMC (6 parts by mass) as a positive electrode active material, the solid electrolyte composition (S-4) prepared in Example 1 (10 parts by mass), and a dispersion medium that was used in the solid electrolyte composition (9 parts by mass) were added thereto, and the components were mixed at 100 rpm for 10 minutes, thereby preparing a composition for a positive electrode of a secondary battery in Test No. 201 shown in Table 5.

(2) Preparation of Compositions For a Positive Electrode of a Secondary Battery in Test Nos. 202 to 205 and c21 to 23

Compositions for a positive electrode of a secondary battery in Test Nos. 202 to 205 and c21 to 23 were prepared in the same manner as the preparation of the composition for a positive electrode of a secondary battery in Test No. 201 except for the fact that only the kinds of the positive electrode active material and the solid electrolyte composition were changed as shown in Table 5.

### Preparation of Composition For Negative Electrode of Secondary Battery

(1) Preparation of a Composition For a Negative Electrode of a Secondary Battery in Test No. 201

180 zirconia beads having a diameter of 5 mm were injected into a 45 ml zirconia container (manufactured by Fritsch Japan Co., Ltd.), and graphite (5 parts by mass) as a negative electrode active material, the solid electrolyte composition (S-4) prepared in Example 1 (10 parts by mass and a dispersion medium that was used in the solid electrolyte composition (9 parts by mass) were added thereto, and the components were mixed at 100 rpm for 10 minutes, thereby preparing a composition for a negative electrode of a secondary battery in Test No. 201 shown in Table 5.

(2) Preparation of Compositions For a Negative Electrode of a Secondary Battery in Test Nos. 202 to 205 and c21 to c23

Compositions for a negative electrode of a secondary battery in Test Nos. 202 to 205 and c21 to c23 were prepared in the same manner as the preparation of the composition for a negative electrode of a secondary battery in Test No. 201 except for the fact that only the kinds of the negative electrode active material and the solid electrolyte composition were changed as shown in Table 5.

### Production of Positive Electrode For Secondary Battery

Each of the compositions for a positive electrode of a secondary battery obtained above was applied onto a 20 μm-thick aluminum foil using an applicator having an arbitrary clearance and dried at 80° C. for two hours. After that, the composition was heated and pressurized using a heat pressing machine so as to obtain an arbitrary density, thereby producing a corresponding positive electrode for a secondary battery.

Meanwhile, the thicknesses of positive electrode active material layers were all 150 μm.

### Production of Electrode Sheet For All-Solid State Secondary Battery

The solid electrolyte composition prepared in Example 1, which is shown in Table 5, was applied onto each of the positive electrodes for a secondary battery produced above using an applicator having an arbitrary clearance and heated and dried at 80° C. for two hours.

After that, the composition for a negative electrode for a secondary battery prepared above was further applied thereonto and heated and dried at 80° C. for two hours. The compositions were heated (at 80° C.) and pressurized (at 60 MPa for one minute) using a heat pressing machine, thereby producing a corresponding electrode sheet for a secondary battery.

Meanwhile, the thicknesses of solid electrolyte composition layers were all 50 μm, and the thicknesses of negative electrode active material layers were all 120 μm.

For the respective electrode sheets for an all-solid state secondary battery produced above, the bonding property and the ion conductivity were evaluated.

(1) Evaluation of Bonding Property

For the evaluation of the bonding property, testing was carried out in the same manner as in Example 1 except for the fact that the subject to which CELLOTAPE was adhered was changed from the solid electrolyte layer in the solid electrolyte sheet to the negative electrode active material layer in the electrode sheet for an all-solid state secondary battery.

(2) Measurement of Ion Conductivity

A disc-shaped piece having a diameter of 14.5 mm as cut out from the electrode sheet for a secondary battery produced above and put into a coin case. That is, a 20 μm-thick copper foil cut out to a disc shape having a diameter of 15 mm was brought into contact with the negative electrode layer in the electrode sheet for a secondary battery, a spacer and a washer were combined thereinto, and the piece was put into a stainless steel 2032-type coin case, thereby producing a coin battery (all-solid state secondary battery) illustrated in FIG. 2. In the same manner as in the production of the cell for measuring ion conductivity in Example 1, a confining pressure (a screw-fastening pressure: 8 N) was applied from the outside of the coin case, a cell for measuring the ion conductivity was produced, and the ion conductivity was measured in the same manner as in Example 1. Meanwhile, in the present measurement, reference sign 15 illustrated in FIG. 2 which is a reference indicates the all-solid state secondary battery having a structure in which the copper foil is present on the negative electrode in the electrode sheet for an all-solid state secondary battery.

The obtained results are summarized in Table 5.

TABLE 5

| | Cell constitution of electrode sheet for | | | | | |
|---|---|---|---|---|---|---|
| | all-solid state secondary battery | | | | | |
| | Composition for | | Composition for | | | |
| | positive electrode | Solid electrolyte | negative electrode | | | |
| | in positive | composition in | in negative | | Ion | |
| | electrode active | solid electrolyte | electrode active | Bonding | conductivity | |
| Test No. | material layer | layer | material layer | property | (mS/cm) | Remark |
| 201 | NMC | S-4 | Graphite | 1 | 0.16 | Present |
| | S-4 | | S-4 | | | Invention |
| 202 | NMC | S-6 | Graphite | 4 | 0.18 | Present |
| | S-6 | | S-6 | | | Invention |
| 203 | LCO | S-6 | Graphite | 4 | 0.19 | Present |
| | S-6 | | S-6 | | | Invention |
| 204 | NMC | S-6 | LTO | 4 | 0.17 | Present |
| | S-6 | | S-6 | | | Invention |
| 205 | NMC | S-11 | Graphite | 4 | 0.46 | Present |
| | S-11 | | S-11 | | | Invention |
| c21 | NMC | T-1 | Graphite | 1 | 0.08 | Comparative |
| | T-1 | | T-1 | | | Example |
| c22 | NMC | T-2 | Graphite | 1 | Not | Comparative |
| | T-2 | | T-2 | | measurable | Example |
| c23 | NMC | T-2 | Graphite | 2 | Not | Comparative |
| | T-2 | | T-2 | | measurable | Example |

<Notes of table>
NMC: Li(Ni_{1/3}Mn_{1/3}Co_{1/3})O₂, lithium nickel manganese cobalt oxide
LCO: LiCoO₂, lithium cobaltate

As is clear from Table 5, it is found that the electrode sheets for an all-solid state secondary battery manufactured using the solid electrolyte composition of the present invention all had high and excellent ion conductivity. In addition, from the comparison between Test Nos. 201 to 205 and Test Nos. c21 to c23, it is found that, in a case in which the electrode sheets contained the siloxane compound having a siloxane bond in a branched shape and the salt of an ion of the metal belonging to Group I or II of the periodic table, the effect of being excellent in terms of the ion conductivity was exhibited. Furthermore, the electrode sheets for an all-solid state secondary battery of Test Nos. 202 to 205 for which the binder was added to the solid electrolyte composition exhibited a favorable bonding property as well as the favorable ion conductivity.

The present invention has been described together with the embodiment; however, unless particularly specified, the present inventors do not intend to limit the present invention to any detailed portion of the description and consider that the present invention is supposed to be broadly interpreted within the concept and scope of the present invention described in the claims.
1: negative electrode collector
2: negative electrode active material layer
3: solid electrolyte layer
4: positive electrode active material layer
5: positive electrode collector
6: operation portion
10: all-solid state secondary battery
11: upper portion-supporting plate
12: lower portion-supporting plate
13: coin battery
14: coin case
15: solid electrolyte sheet or all-solid state secondary battery
S: screw

What is claimed is:

1. A solid electrolyte composition comprising:
an inorganic solid electrolyte having conductivity of ions of metals belonging to Group I or II of the periodic table;
a siloxane compound having a siloxane bond in a branched shape; and
a salt of an ion of a metal belonging to Group I or II of the periodic table.

2. The solid electrolyte composition according to claim 1,
wherein the siloxane compound is a siloxane compound including a partial structure represented by General Formula (S), 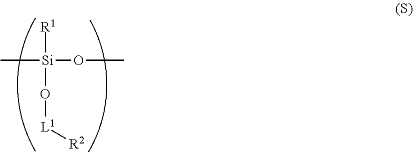
in General Formula (S), R¹ represents a hydrogen atom, a halogen atom, a hydrocarbon group, or —O-L¹-R², L¹ represents a single bond, an alkylene group, an alkenylene group, an arylene group, —C(═O)—, —N(Ra)-, or a divalent group formed of a combination thereof, Ra represents a hydrogen atom, an alkyl group, or an aryl group, and R² represents a hydrogen atom, a hydroxy group, an amino group, a mercapto group, an epoxy group, a cyano group, a carboxy group, a sulfo group, a phosphoric acid group, an alkyl group, an alkenyl group, an alkynyl group, an aryl group, a group including one or more oxyalkylene groups, a group including one or more ester bonds, a group including one or more amide bonds, or a group including one or more siloxane bonds.

3. The solid electrolyte composition according to claim 1,
wherein the siloxane compound is a siloxane oligomer having a mass average molecular weight of 500 or more and 10,000 or less.

4. The solid electrolyte composition according to 2,
wherein —O-L¹-R² that is bonded to a silicon atom is a group represented by General Formula (1s),
in General Formula (1s), L²¹ represents an alkylene group or an arylene group, and R²¹ represents a hydrogen atom, an alkyl group, an alkenyl group, or an aryl group.

5. The solid electrolyte composition according to claim 4,
wherein a mole fraction of the group represented by General Formula (1s) is 5 mol % or more.

6. The solid electrolyte composition according to claim 1,
wherein a content of the siloxane compound is 0.1 to 20 parts by mass with respect to 100 parts by mass of the inorganic solid electrolyte in solid components in the solid electrolyte composition.

7. The solid electrolyte composition according to claim 1,
wherein the inorganic solid electrolyte is selected from compounds represented by any one of the following formulae,
LiₓₐLa_{ya}TiO₃
0.3≦xa≦0.7, and 0.3≦ya≦0.7
Li_{xb}La_{yb}Zr_{zb}M^{bb}_{mb}O_{nb}
5≦xb≦10, 1≦yb≦4, 1≦zb≦4, 0≦mb≦2, and 5≦nb≦20
M^{bb} at least one element selected from the group consisting of Al, Mg, Ca, Sr, V, Nb, Ta, Ti, Ge, In, and Sn
Li_{3.5}Zn_{0.25}GeO₄
LiTi₂P₃O₁₂
Li_{(1+xh+yh)}(Al, Ga)ₓₕ(Ti, Ge)₍₂₋ₓₕ₎Si_{yh}P_{(3-yh)}O₁₂
0≦xh≦1 and 0≦yh≦1
Li₃PO₄
LiPON
LiPOD¹
D¹ represents at east one element selected from the group consisting of Ti, V, Cr, Mn, Fe, Co, Ni, Cu, Zr, Nb, Mo, Ru, Ag, Ta, W, Pt, and Au
LiA¹ON
A¹ represents at least one element selected from the group consisting of Si, B, Ge, Al, C, and Ga
Li_{xc}B_{yc}M^{cc}_{zc}O_{nc}
0<xc≦5, 0<yc≦1, 0≦zc≦1, and 0<nc≦6
M^{cc} is at least one element selected from le group consisting of C, S, Al, Si, Ga, Ge, In and Sn
Li₍₃₋₂ₓₑ₎M^{ee}ₓₑD^{ee}O
0≦xe≦0.1
M^{ee} is a divalent metallic atom, and D^{ee} is a halogen atom or a combination or more kinds of halogen atoms
Li_{xf}Si_{yf}O_{zf}
1≦xf≦5, 0<yf≦3, and 1≦zf≦10
Li_{xg}Si_{yg}O_{zg}
1≦xg≦3, 0<yg≦2, and 1≦zg≦10

8. The solid electrolyte composition according to claim 1,
wherein the inorganic solid electrolyte is a compound represented by General Formula (SE),
L^{aa}ₐ₁M^{aa}_{b1}P_{c1}S_{d1}A^{aa}ₑ₁ (SE)
in General Formula (SE), L^{aa} represents an element selected from Li, Na, and K, M^{aa} represents an element selected from B, Zn, Sn, Si, Cu, Ga, Sb, Al, and Ge, and A^{aa} represents I, Br, Cl, or F, a1 to e1 represent compositional ratios of the respective elements, and a1:b1:c1:d1:e1 satisfies 1 to 12:0 to 1:1:2 to 12:0 to 5.

9. The solid electrolyte composition according to claim 1,
wherein the salt of a metallic ion belonging to Group I or II of the periodic table is a lithium salt.

10. The solid electrolyte composition according to claim 1, further comprising:
a binder.

11. The solid electrolyte composition according to claim 10,
wherein the binder is a hydrocarbon resin, a fluororesin, an acrylic resin, or a polyurethane resin.

12. A method for manufacturing an electrode sheet for an all-solid state secondary battery, the method comprising:
applying the solid electrolyte composition according to claim 1 onto a metal foil; and
forming a film.

13. An electrode sheet for an all-solid state secondary battery having a positive electrode active material layer, a solid electrolyte layer, and a negative electrode active material layer in this order,
wherein any one layer of the positive electrode active material layer, the solid electrolyte layer, and the negative electrode active material layer contains an inorganic solid electrolyte having conductivity of ions of metals belonging to Group I or II of the periodic table, a siloxane compound having a siloxane bond in a branched shape, and a salt of an ion of a metal belonging to Group I or II of the periodic table, respectively.

14. An all-solid state secondary battery constituted using the electrode sheet for an all-solid state secondary battery according to claim 13.

15. A method for manufacturing an all-solid state secondary battery, the method comprising:
manufacturing an all-solid state secondary battery having a positive electrode active material layer, a solid electrolyte layer, and a negative electrode active material layer in this order through the manufacturing method according to c
